(19) United States
(12) Patent Application Publication
(10) Pub. No.: US 2018/0131848 A1
(43) Pub. Date: May 10, 2018

(54) MULTI-MODAL UNDERWATER CAMERA ACCESSORY APPARATUS

(71) Applicant: Eric Laliberte, Gatineau (CA)

(72) Inventor: Eric Laliberté, Gatineau (CA)

(21) Appl. No.: 15/804,354

(22) Filed: Nov. 6, 2017

Related U.S. Application Data
(60) Provisional application No. 62/418,333, filed on Nov. 7, 2016.

(51) Int. Cl. H04N 5/225; F16M 13/04; G03B 17/08; G03B 17/56

(52) U.S. Cl. CPC H04N 5/2253; G03B 17/561; G03B 17/08; F16M 13/04

(57) ABSTRACT

Disclosed herein is a multi-modal underwater camera accessory apparatus operable in multiple modes by an operator. The apparatus includes a shaft, camera mount, and a wing rotationally connected to the shaft. The shaft has a proximal end and a distal end, the proximal end suitable for manipulation by the operator. The camera mount is connected to the shaft proximate to the distal end of the shaft. The camera mount is suitable for receiving the underwater camera to be manipulated by the operator. The wing is rotationally connected to the shaft such that the wing may be configured by the operator in at least one of two positions including: a first position whereat the wing is at a first angle with respect to the shaft; and a second position whereat the wing is at a second angle with respect to the shaft, the second angle being smaller than the first angle. The mode of operation of the apparatus is depends on the at least one of two positions of the wing.

### CROSS-REFERENCE TO RELAYED APPLICATIONS

The present application is related to U.S. provisional patent application, Ser. No. 62/418,333, filed Nov. 7, 2016, for UNDERWATER STABILITY AND BUOYANCY CAMERA LIGHTING AND ACCESSORIES SYSTEM, by Eric Laliberté, included by reference herein and for which benefit of the priority date is hereby claimed.

### TECHNICAL FIELD

This application relates to underwater photography in general, and to a multi-modal underwater camera accessory apparatus, in particular.

### BACKGROUND OF THE INVENTION

Traditionally, when scuba diving or snorkeling and shooting underwater pictures and videos with a small hand held camera, results may be disappointing as it may be difficult to keep subjects in the target photo or video area. Furthermore, capturing true colours and capturing video while diving may be a challenge due to operator interference, aim, stability and equipment size & weight. There is therefore a need for addressing at least these problems and further related problems by providing a maneuverable and portable dive console.

A known apparatus for stabilizing a camera when used in an under-water environment. comprises a hand grab having a flat top surface, the flattop surface of the hand grab slidably engaging a pair of elongate parallel rods at a proximal end of the rods, the rods further slidably engaging, at a distal end thereof, a platform resting upon the rods which engages a camera base, and a fin of predetermined configuration, the fin being slid-ably engaged upon the rods at a position between the proximal and distal ends thereof, the structures being movable along the length of the rods to establish a stabilization of the camera as a user is moving through water, or as water is moving past the camera. Further, at least one distally directed light source is provided suitably engaged to or provided on an undersurface of the fin.

However such an apparatus may have several shortcomings such as that it may be awkward to transport, have operational limitations, be unwieldy to operate, or have limited possibilities for accessories, to list but a few examples.

There is therefore still a need for addressing at least these problems and further related problems by providing improvements in this field.

### SUMMARY

According to one aspect of the present invention, there is provided a multi-modal underwater camera accessory apparatus operable in multiple modes by an operator. The apparatus includes a shaft, camera mount, and a wing rotationally connected to the shaft. The shaft has a proximal end and a distal end, the proximal end suitable for manipulation by the operator. The camera mount is connected to the shaft proximate to the distal end of the shaft. The camera mount is suitable for receiving the underwater camera to be manipulated by the operator. The wing is rotationally connected to the shaft such that the wing may be configured by the operator in at least one of two positions including: a first position whereat the wing is at a first angle with respect to the shaft; and a second position whereat the wing is at a second angle with respect to the shaft, the second angle being smaller than the first angle. The mode of operation of the apparatus depends on the at least one of two positions of the wing.

In some embodiments, a second wing is provided which is a mirror image of the first said wing, the second wing rotationally connected to the shaft such that the second wing may also be configured in at least one of the said first and second positions. In some embodiments, the camera mount enables the operator to orient the underwater camera towards a subject at an arbitrary angle with respect to the shaft. In some embodiments, the arbitrary angle is aligned with the shaft. In some embodiments, the orientation of the underwater camera is towards the operator such that the operator is in the field of view of the underwater camera. In some embodiments, the orientation of the underwater camera is away from the operator such that the operator is not in the field of view of the underwater camera. In some embodiments, the shaft includes an inner channel, an outer channel, and a mechanism to set the length of the shaft through operator manipulation. In some embodiments, the mechanism to set the length of the shaft includes at least one of: a groove, a hole provided on the outer channel, a screw, and a quick lock ring provided on the outer channel for collapsing the outer channel onto the inner channel. In some embodiments, the mechanism to set the length of the shaft includes a spring loaded pin provided on the inner channel and at least one hole provided on the outer channel. In some embodiments, the inner channel further includes a tool such that when the inner channel is removed from the outer channel, the tool can be used by the operator. In some embodiments the tool is a knife. In some embodiments, the shaft includes a buoyancy component to affect the buoyancy of the apparatus. In some embodiments, the buoyancy component includes a ballast for receiving one of a substance that is lighter than water, heavier than water, and the same weight as water. In some embodiments, the buoyancy component includes at least one of a foam pad slidably engaged onto the shaft, a foam core provided inside the shaft, a chamber formed inside the shaft, and a chamber attachable to the shaft. In some embodiments, the shaft includes a ballast plug provided at one end of the shaft to create a ballast chamber inside the shaft. In some embodiments, the shaft includes an accessory adapter that snaps onto the shaft to receive at least one of a light, a shaker tool, a knife, a counter weight case, a dive computer, a compass, and a bungee cord. In some embodiments, the camera mount includes a hinge including at least two segments and a rotational component, the hinge thereby allowing the operator to orient the camera with respect to two degrees of freedom relative to the shaft. In some embodiments, the wing is rotationally connected to the shaft by one of a pivot bracket and a lighting arm. In some embodiments, a lighting arm is provided having two ends, the lighting arm connected at one end to the shaft proximate to the camera mount, the lightning arm connected at the other end to at least one of a light bracket that allows the operator to add a light and a wing bracket connected to the wing. In some embodiments, the mode of operation includes at least one mode selected from a deployed mode, a stowed mode, a forward mode, a selfie mode, a bottom hover mode, a monopod mode, a tool mode, a writing mode, and a reduced width mode.

Other aspects and features of the present application will become apparent to those ordinarily skilled in the art upon review of the following description of specific embodiments of a multi-modal underwater camera accessory apparatus in conjunction with the accompanying drawing figures.

### BRIEF DESCRIPTION OF THE DRAWINGS

Embodiments of the present application will now be described, by way of example only, with reference to the accompanying drawing figures, wherein:

FIG. 1 illustrates an embodiment of the present application;

FIG. 2 illustrates another embodiment of the present application;

FIG. 3 illustrates the embodiment of FIG. 2, wherein the camera is oriented towards the operator;

FIG. 4 illustrates another embodiment of the present application;

FIG. 5 illustrates another embodiment of the present application;

FIG. 6 illustrates another embodiment of the present application;

FIG. 7 illustrates another embodiment of the present application;

FIG. 8 illustrates another embodiment of the present application;

FIG. 9 illustrates a top view of a preferred embodiment of the application in a deployed forward mode;

FIG. 10 illustrates a side view of the preferred embodiment of the application in a deployed forward mode;

FIG. 11 illustrates a top view of the preferred embodiment of the application in a tow or selfie mode;

FIG. 12 illustrates a side view of the preferred embodiment of the application in a tow or selfie mode;

FIG. 13 illustrates a top view of the preferred embodiment of the application in a collapsed/carrying mode;

FIG. 14 illustrates another top view of the preferred embodiment of the application in a collapsed/carrying mode;

FIG. 15 illustrates a side view of the preferred embodiment of the application in a collapsed/carrying mode;

FIG. 16 illustrates an exploded parts view of the preferred embodiment of the application;

FIG. 17 illustrates a side view of a wing with adjustable wing buoyancy in a preferred embodiment;

FIG. 18 illustrates a top view of a preferred embodiment in a deployed forward mode;

FIG. 19 illustrates a top view of a preferred embodiment in a deployed tow or selfie mode;

FIG. 20 illustrates a side view of a preferred embodiment in a deployed monopod mode;

FIG. 21 illustrates a side view of a preferred embodiment in a deployed bottom hover mode;

FIG. 22 illustrates a top view of a preferred embodiment in a deployed tool mode;

FIG. 23 illustrates a top view of a preferred embodiment in a deployed communication mode;

FIG. 24 illustrates a top view of a preferred embodiment in a collapsed or carrying mode;

FIG. 25 illustrates a side view of a preferred embodiment in the collapsed or carrying mode;

FIG. 26 is a perspective view of an other preferred embodiment of the present application;

FIG. 27 is a side view of the other preferred embodiment of the present application;

FIG. 28 is a front view of the other preferred embodiment of the present application;

FIG. 29 is a top view of the other preferred embodiment of the present application;

FIG. 30A is a side view of a basic shaft that can be used in some embodiments of the present application;

FIG. 30B is a front view of the basic shaft that can be used in some embodiments of the present application;

FIG. 31A is a side view of a shaft head handle base assembly that can be used in some embodiments of the present application;

FIG. 31B is a top view of the shaft head handle base assembly that can be used in some embodiments of the present application;

FIG. 31C is a rear view of the shaft head handle base assembly that can be used in some embodiments of the present application;

FIG. 32A is a front view of a hinge that can be used in some embodiments of the present application;

FIG. 32B is a rear view of the hinge that can be used in some embodiments of the present application;

FIG. 32C is a side view of the hinge that can be used in some embodiments of the present application;

FIG. 32D is a top view of the hinge that can be used in some embodiments of the present application; and

FIG. 32E is a bottom view of the hinge that can be used in some embodiments of the present application.

Like reference numerals are used in different figures to denote similar elements.

### DETAILED DESCRIPTION OF THE DRAWINGS

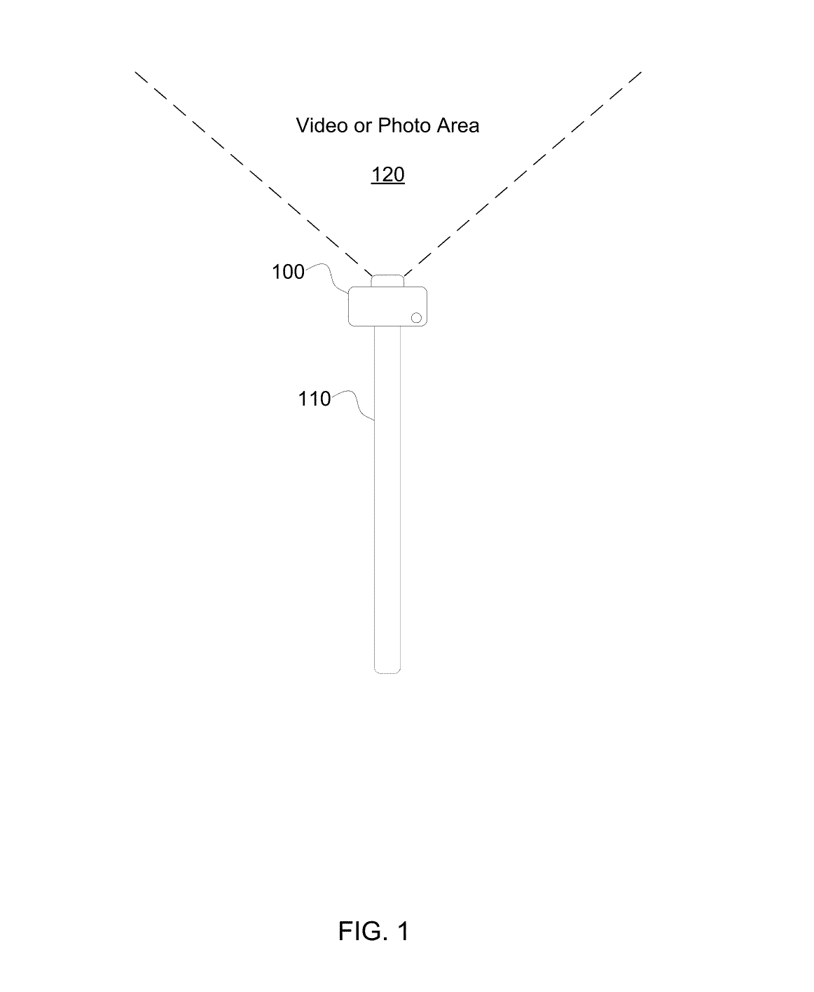

Referring to the drawings, FIG. 1 illustrates an embodiment of the present application. As shown in the drawing, a camera 100 is attached to a shaft 110 that can help point the camera 100 towards a subject and make it easier to keep the subjects in the video or photo area 120. This embodiment enables the operation of the camera 100 in tight places and also capture sea life up close.

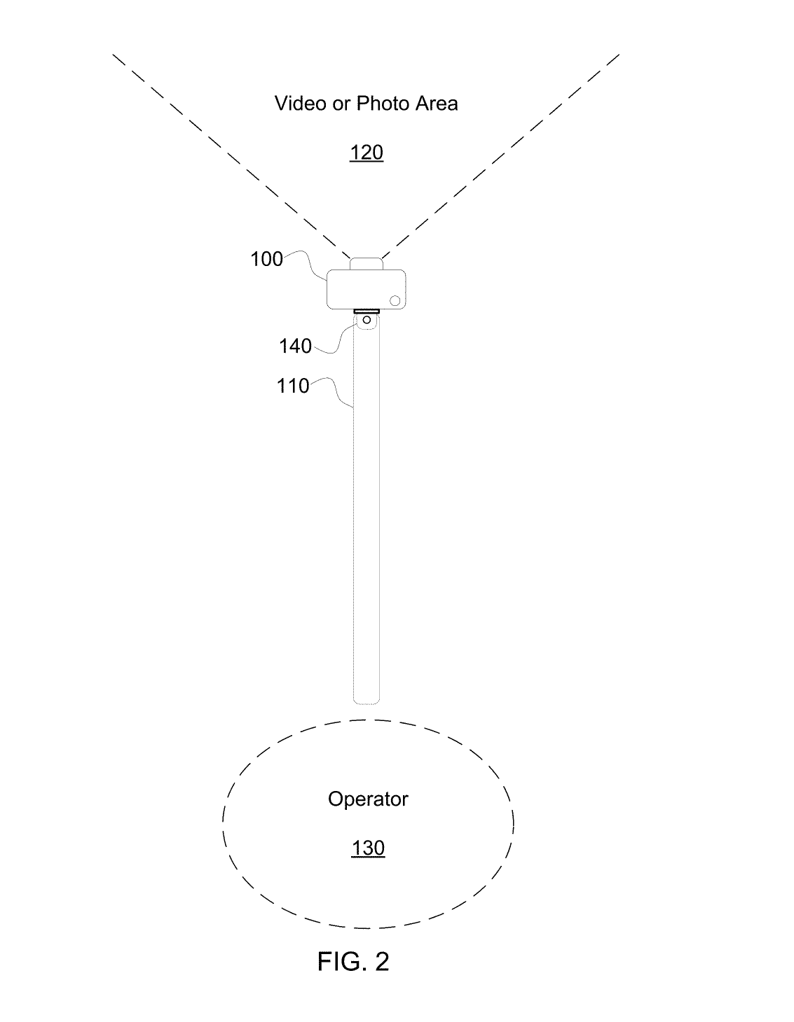

FIG. 2 illustrates another embodiment of the present application. As shown in the drawing, building on the shaft embodiment that puts the camera 100 a short distance away from the operator 130, by adapting a rotating hinge 140 (e.g. plastic or aluminium or other material camera mount) to the shaft, it is then possible for the operator 130 to take pictures or videos that include at least themselves, i.e. selfies. As shown in the drawing, advantageously, the camera 100 can continue to be utilised in a forward orientation. Although not shown in the drawing, the addition of a rotating hinge 140 (e.g. plastic or aluminium or other material camera mount), and more generally, a rotating camera mount, enables the orientation of the camera 100 at any arbitrary angle relative to the shaft 110.

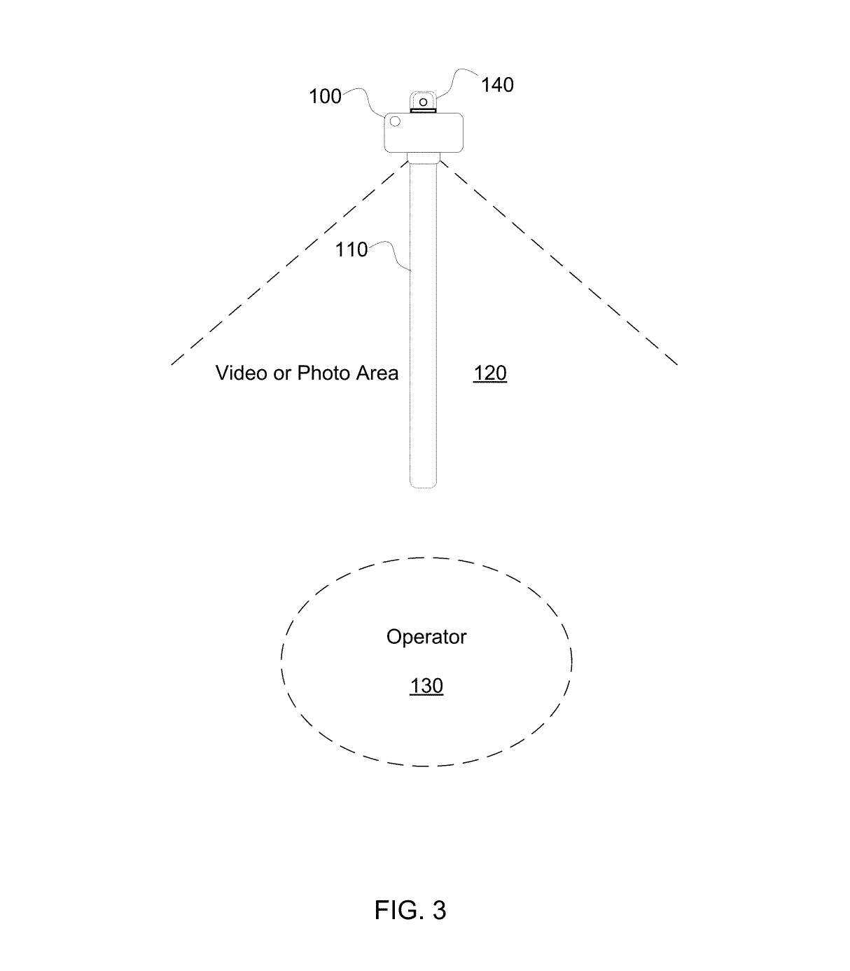

FIG. 3 illustrates the embodiment of FIG. 2, wherein the camera is oriented towards the operator. As shown in the drawing, the operator 130 is enabled to orient the camera 110 such that the operator 130 is in the frame of the video or photo area 120.

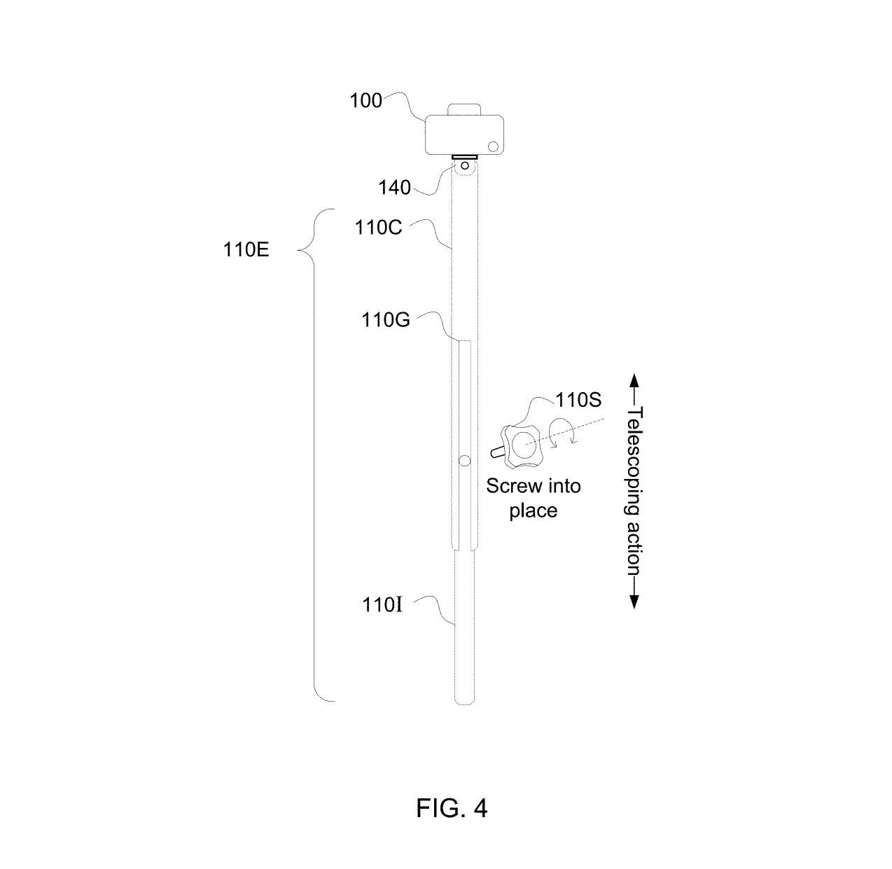

FIG. 4 illustrates another embodiment of the present application. As shown in the drawing, by making the shaft 110 telescopic, the device can be compact, making it much easier to carry, while increasing the overall deployed length and solving the problem of cumbersome packing arrangements for travel: for transportation and travel, an elongate device may be initially cumbersome because of its length and may not easily fit in a suitcase. The telescoping action addresses this problem: the extensible shaft 110E is provided with a groove 110G on the outer channel 110C to allow a screw 110S fixed to the inner channel 110I to slide in a collapsed or extended position. Although not expressly shown in the drawing, the mechanism can be used to enable multiple length configurations between the collapsed and extended position. In an alternative embodiments, the groove 110G is not provided and instead a bolt is used to keep the interior channel 110I in place, or a quick lock ring is provided on the outer channel 110C collapsing the outer channel 110C onto the inner channel 110I.

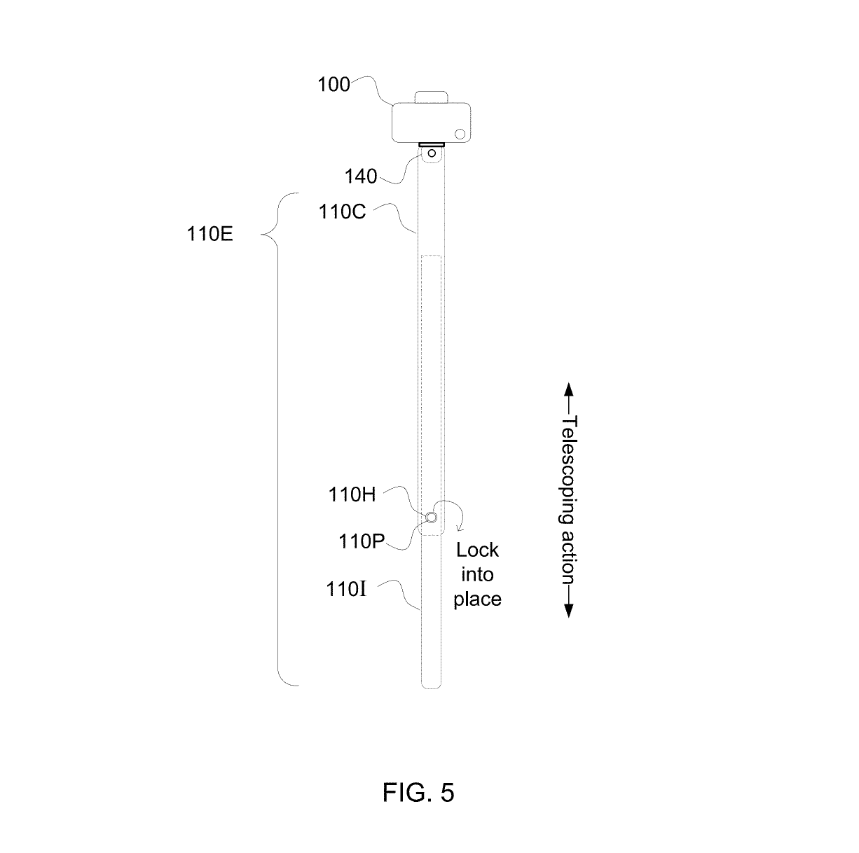

FIG. 5 illustrates another embodiment of the present application. As shown in the drawing, an alternative to the groove 100G and screw 100S mechanism of FIG. 4 is illustrated. A spring loaded pin 110P in the inner channel 100I clips into a hole 110H provided on the outer channel 110C thereby allowing the inner channel 110I to slide in a collapsed or extended position. Although not expressly shown in the drawing, multiple holes 110H could be provided to enable multiple length configurations between the collapsed and extended position.

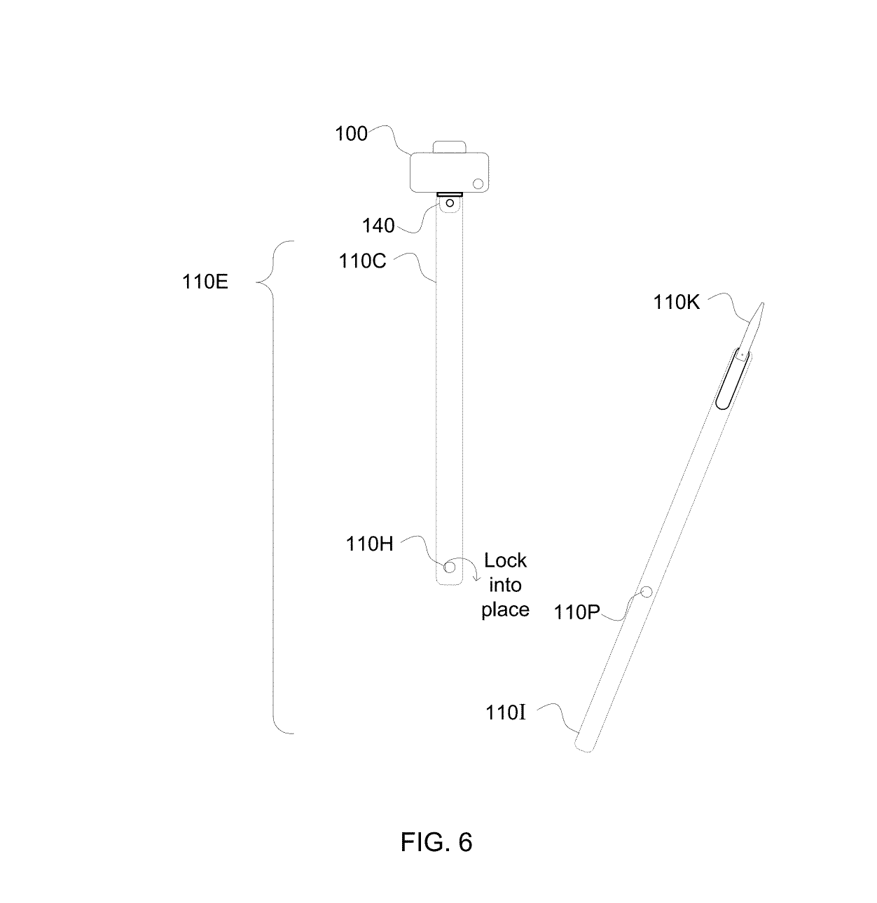

FIG. 6 illustrates another embodiment of the present application. As shown in the drawing, the inner channel 110I has been adapted for the use of a retractable tool, which in this example is a knife 110K, and it is contemplated, that other tools could be adapted and enabled for use in the same fashion. Alternate embodiments without a tool, however, could prove useful in simpler (and more economical) options, the presence or choice of tool depending on the specific application.

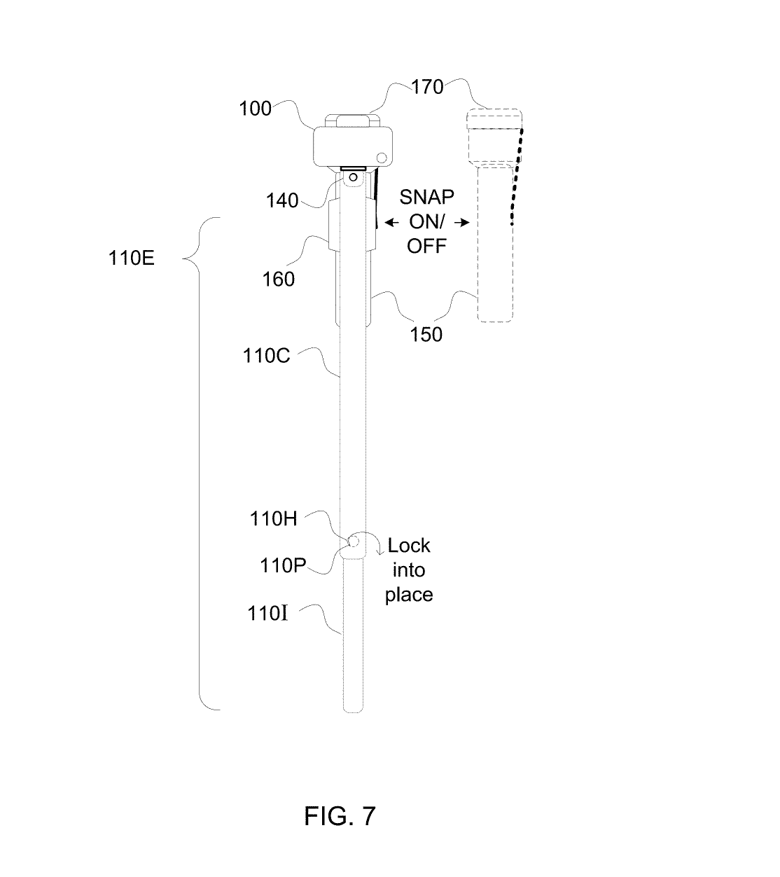

FIG. 7 illustrates another embodiment of the present application. Water absorbs light wavelengths affecting visible colour depending on depth, surface conditions and available sunlight. Colour loss sequence begins with red, orange, yellow, green and blue. As a result, video or photo results are generally disappointing and do not represent the true colours of the underwater flora and fauna. To counter this problem, lighting is provided to render colourful results at any depth. In this embodiment, a scuba light 150 was added to the device below the camera 100. A fixed bracket with a scuba light snap-in adaptor bracket 160 was therefore attached to the hinge 140 under the camera 100. Testing the light while recording a photo or video can create an unexpected hot spot, such as for example at close range or in low light conditions, making the recorded subject in some cases unreadable. To address this situation, as shown in the drawing, a tethered white light diffuser cap 170 is provided to cover the scuba light 150 source so that the hot spot would be reduced or does not occur when used at night or close range. The diffuser 170 can be removed for daylight or long range lighting. The diffuser 170 also protects the light when applied.

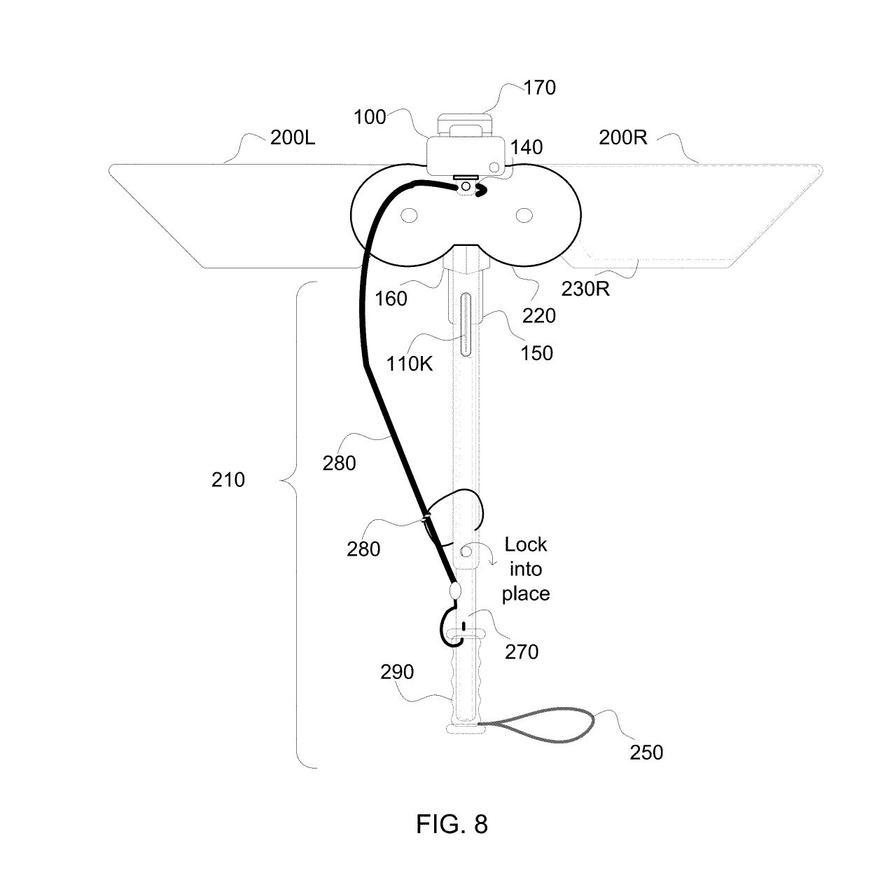

FIG. 8 illustrates another embodiment of the present application. Up to this point in the embodiments shown, when the shaft 210 is fully extended along with a fixed light 150, it may be heavy to handle with one arm, such as for example because the extended length may make it unstable and prone to vibrations, such as those generated by operator fatigue. There was therefore a need for increased stability and buoyancy without compromise to the compact advantage for travelling. As shown in the drawing, there are illustrated at least one of: a collapsible stability wing 200, 200L, 200R, a pivot bracket 220, an extensible shaft 210, a handle 290, a wrist strap 250, a camera 100, a knife 110K, a foam pad 230, a foam core 270, a bungee cord 280, a light diffuser 170, and a light bracket 160 option.

In a manner similar to an aircraft, as shown in the drawing, a collapsible wing 200, 200L, 200R system is provided to either counter vibrations, to reduce rotation, or increase vertical or horizontal stability (roll, pitch and yaw). The wing 200,200L,200R rotates between the upper and lower pivot brackets 220 held in place by a screw rivet permitting the wing 200,200L,200R to rotate between the brackets 220. The lower pivot bracket inner edge is circular, with two ending angled cuts to lock the wing's inner edge to either angled positions so that the wings 200,200L,200R are fully deployed or half deployed where limited width is an issue in a reduced width mode. The J-shape of the wing's 200,200L,200R forward edge gives it its rigidity. When deployed, the wing's inner J edge stops against the pivot bracket 220 to prevent over rotation. Although not expressly shown in the drawing, alternative wing profiles are contemplated, and within the scope of the present application. In some embodiments, the wing pivot bracket 220 always follows the direction of the video or photo camera, such as for example by mounting it through the lighting bracket 160 already mounted onto the hinge. As shown in the drawing, increased buoyancy was achieved by adding foam pads 230 tucked in the J shaped edge under each wing 200.

The foam pads 230,230R (left not visible) are a flexible solution to adjust buoyancy for different lighting system weight and device use in fresh or salt water. With the adjustable buoyancy, in some embodiments, a second light can be attached thereby having one light under each wing 200L, 100R which further balances the device and keeps the camera 100 oriented right side up. In some embodiments, an additional foam pad 230 is added under the pivot bracket 220 when additional lighting and accessories are popped on. Buoyancy can be adjusted by adding or subtracting wing length column sections of interconnecting foam under the wing and into the J shaped edge.

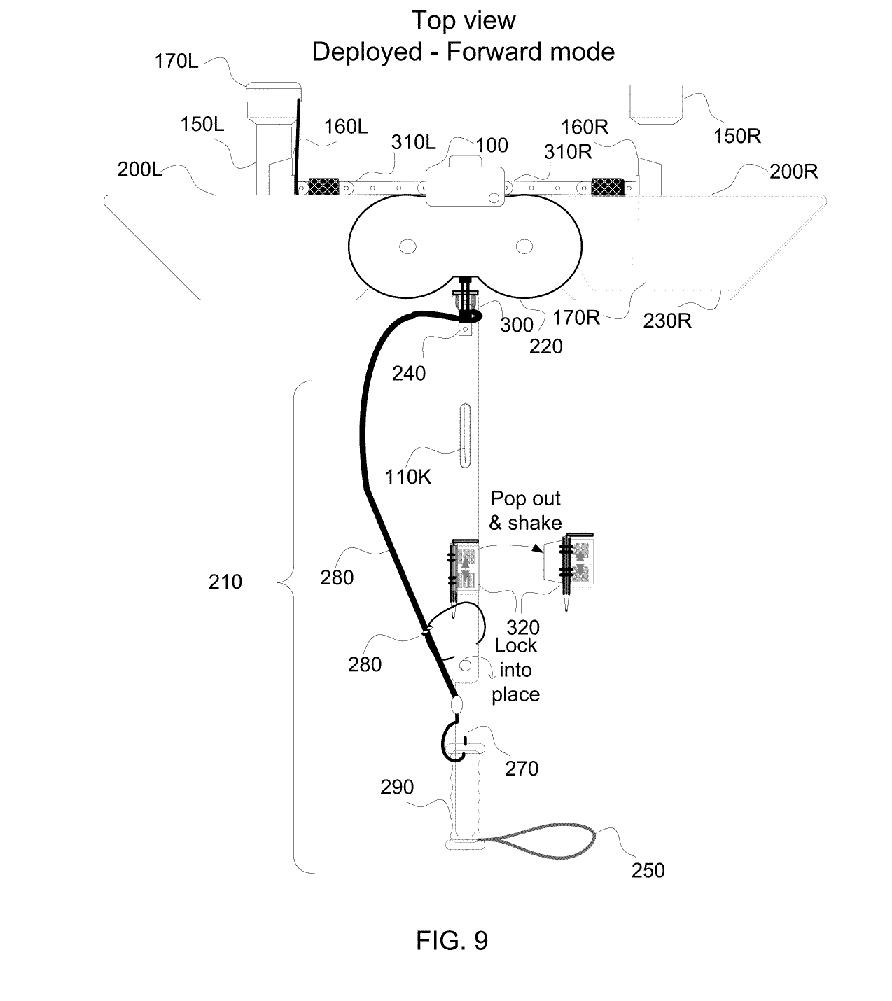

FIG. 9 illustrates a top view of a preferred embodiment of the application in a deployed forward mode. As shown in the drawing, a hinge 300/camera mount, lighting arms 310L, 310R, as well as a pop out tool 320 (e.g. shake/pencil tool) are provided. The hinge 300/camera mount 240, lighting arms 310L, 310R, and wings 200L, 200R are configured in a deployed forward mode.

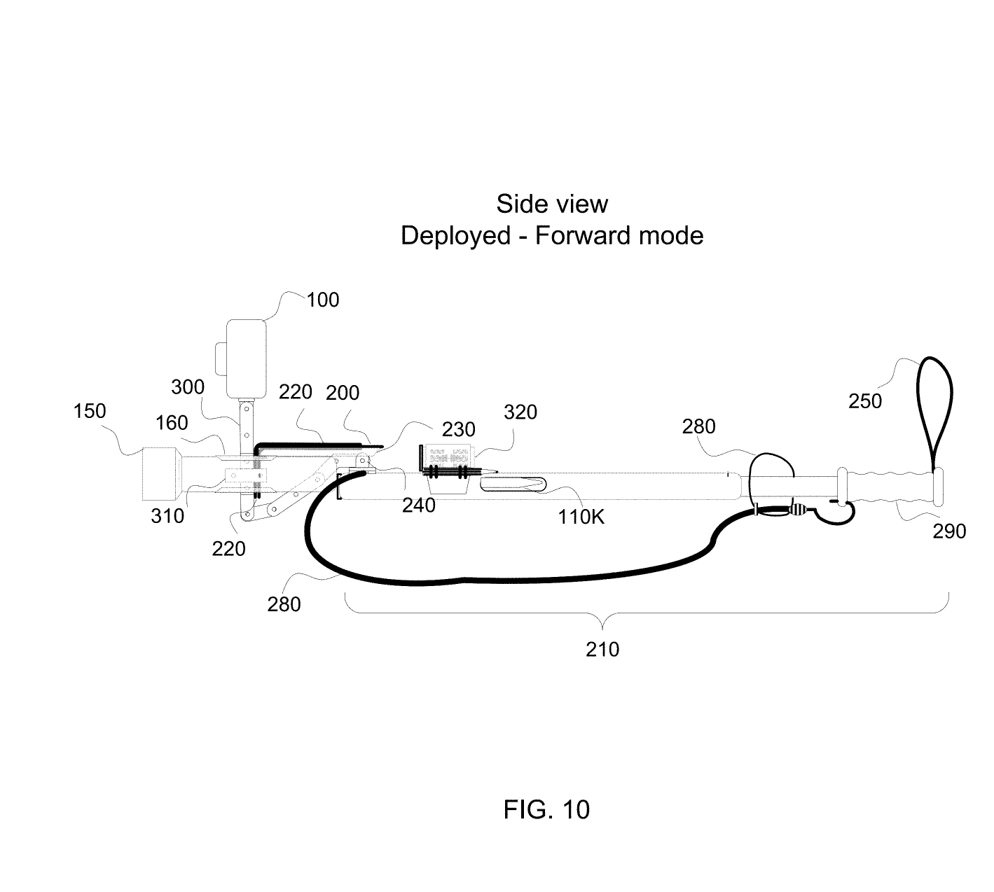

FIG. 10 illustrates a side view of the preferred embodiment of the application in a deployed forward mode. As shown in the drawings, the hinge 300/camera mount 240, lighting arms 310, and wings 200 are configured in a deployed forward mode.

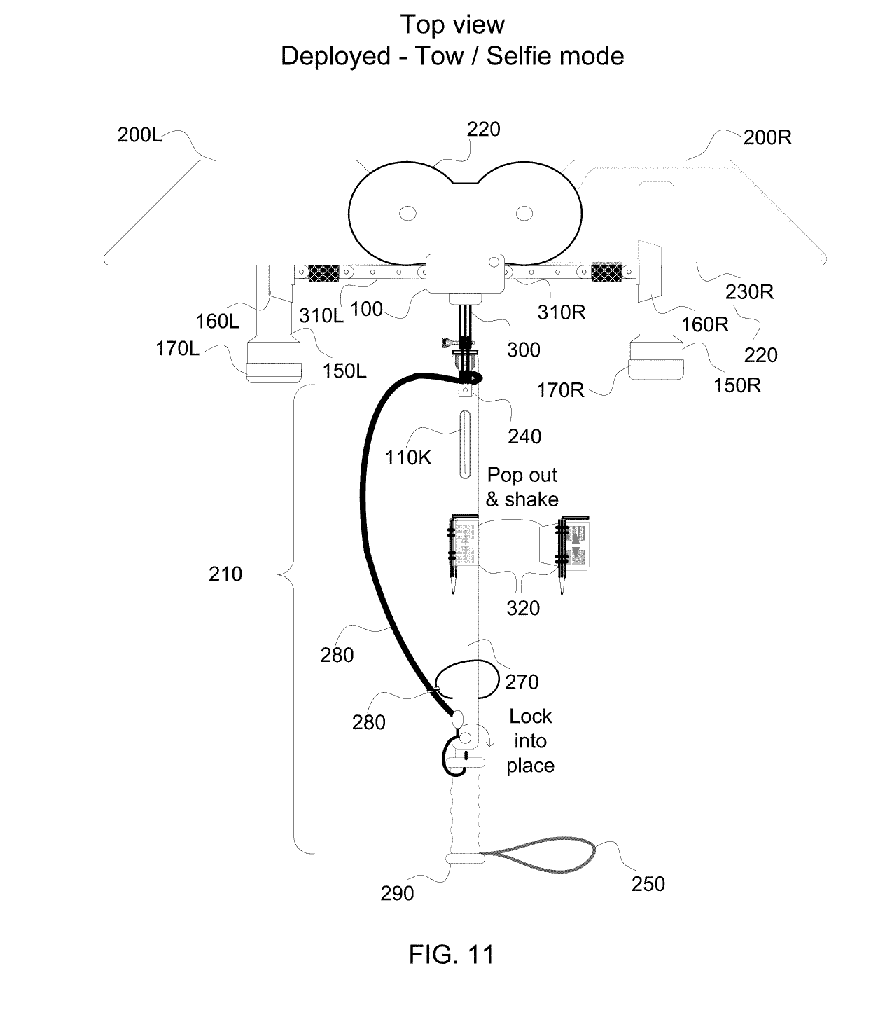

FIG. 11 illustrates a top view of the preferred embodiment of the application in a tow or selfie mode. As shown in the drawings, the hinge 300/camera mount 240, lighting arms 310L, 310R, and wings 200L, 200R are configured in a tow or selfie mode.

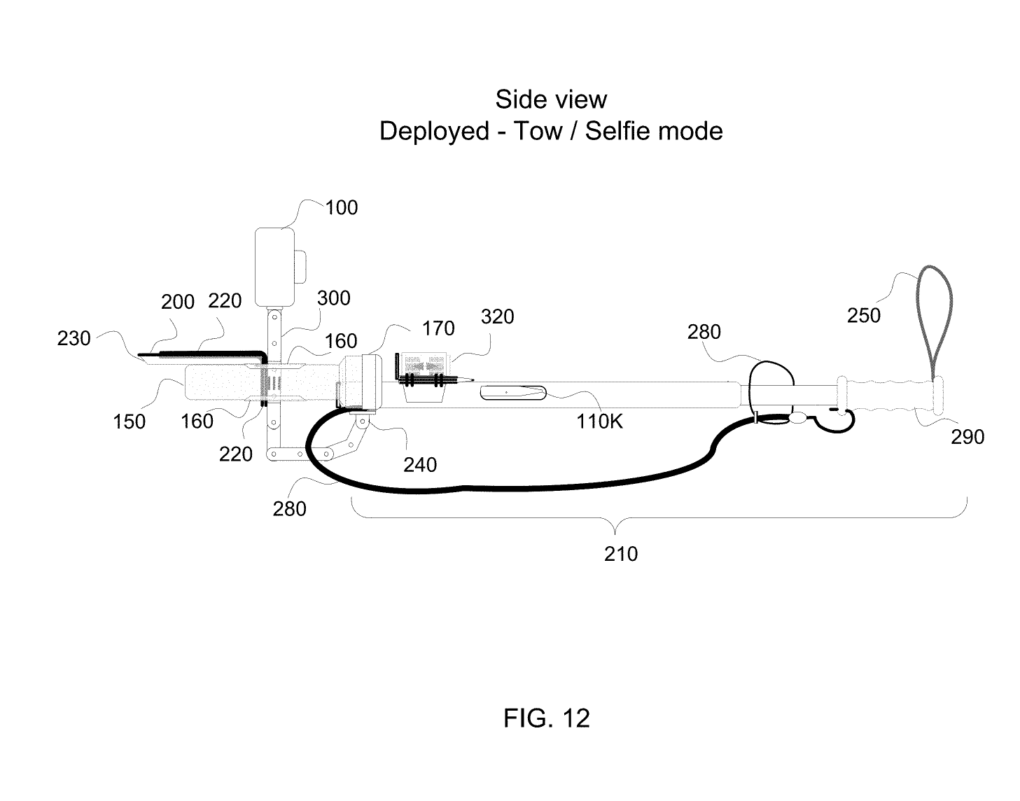

FIG. 12 illustrates a side view of the preferred embodiment of the application in a tow or selfie mode. As shown in the drawings, the hinge 300/camera mount 240, lighting arms (not visible), and wings 200 are configured in a tow or selfie mode.

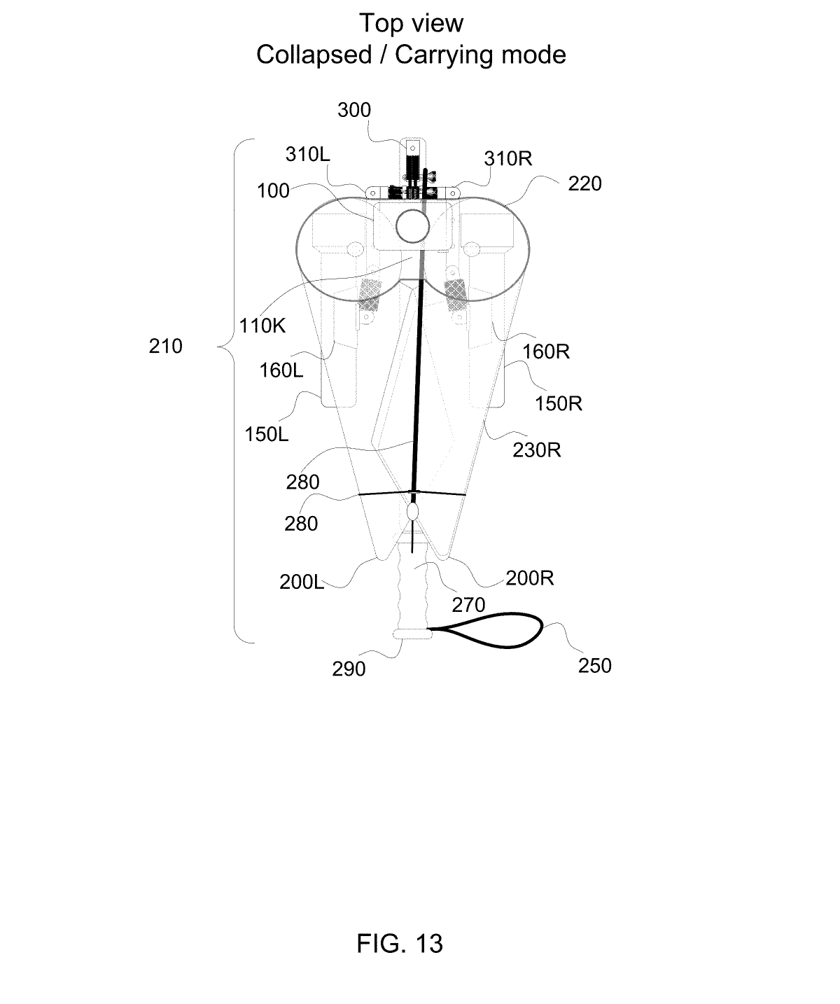

FIG. 13 illustrates a top view of the preferred embodiment of the application in a collapsed/carrying mode. As shown in the drawing, the wings 200L, 200R are illustrated transparently so the fact that the hinge 300, lighting arms 310L, 310R, and wings 200L, 200R are folded onto the shaft 210 which is fully collapsed can better be appreciated. The bungee cords 280 are used to secure the wings 200L, 200R and to keep the device compact.

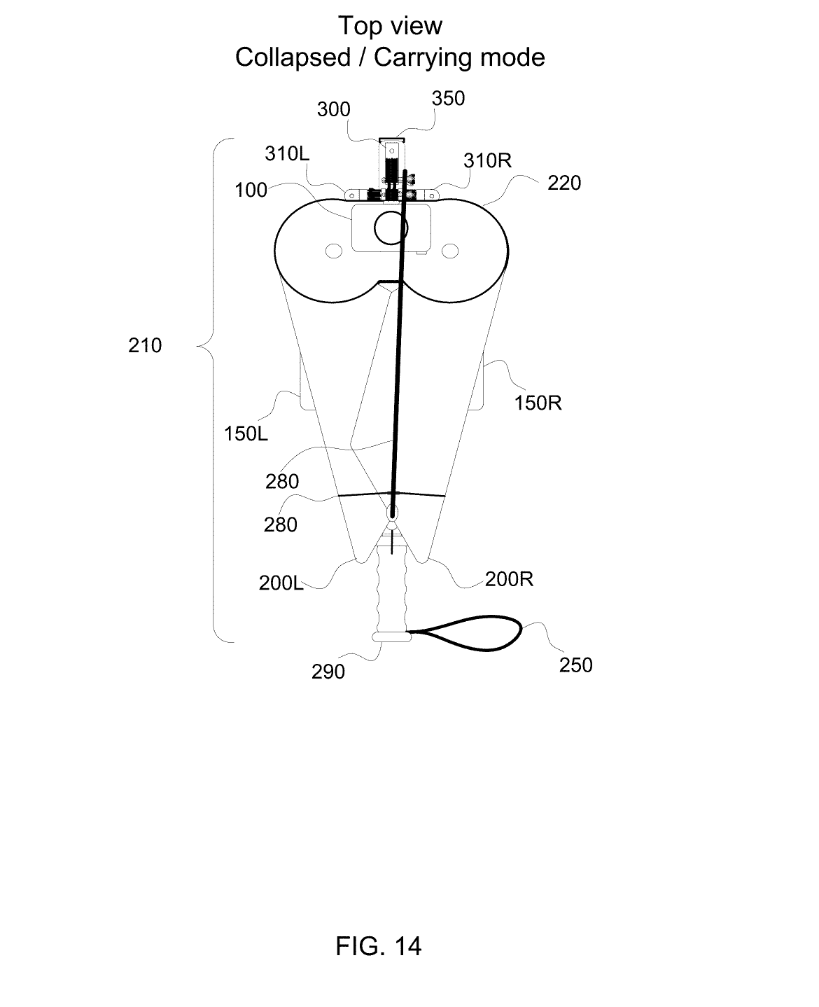

FIG. 14 illustrates another top view of the preferred embodiment of the application in a collapsed/carrying mode. As shown in the drawing, the wings 200L, 200R are illustrated opaquely so as to show the fact that advantageously the lights 150L, 150R and camera 100 are kept substantially away from the edges of the device where they may be harmed during transport.

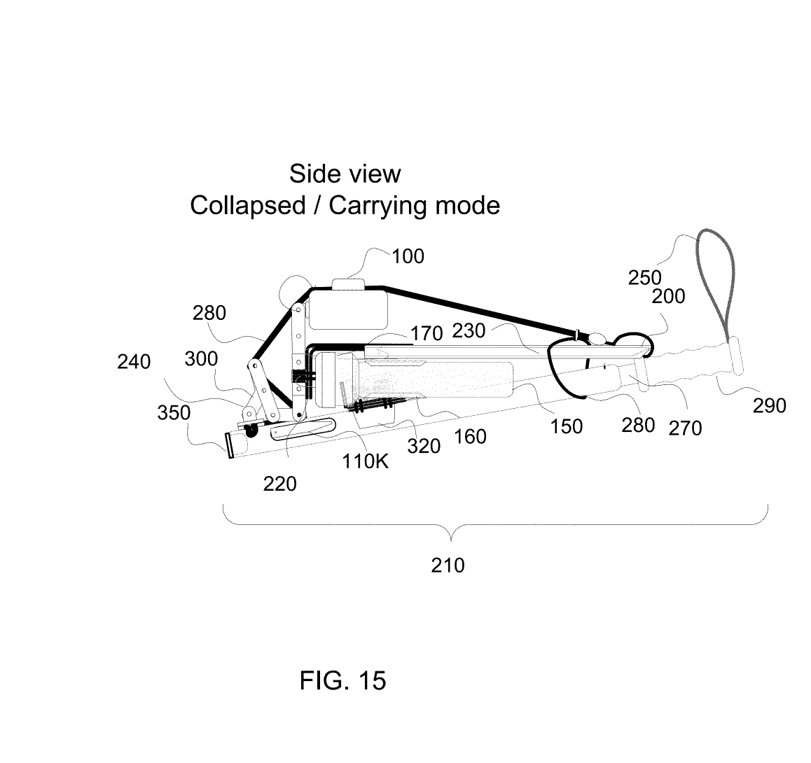

FIG. 15 illustrates a side view of the preferred embodiment of the application in a collapsed/carrying mode. As shown in the drawing, the lights 150 and camera 100 are advantageously kept substantially away from the edges of the device where they may be harmed during transport.

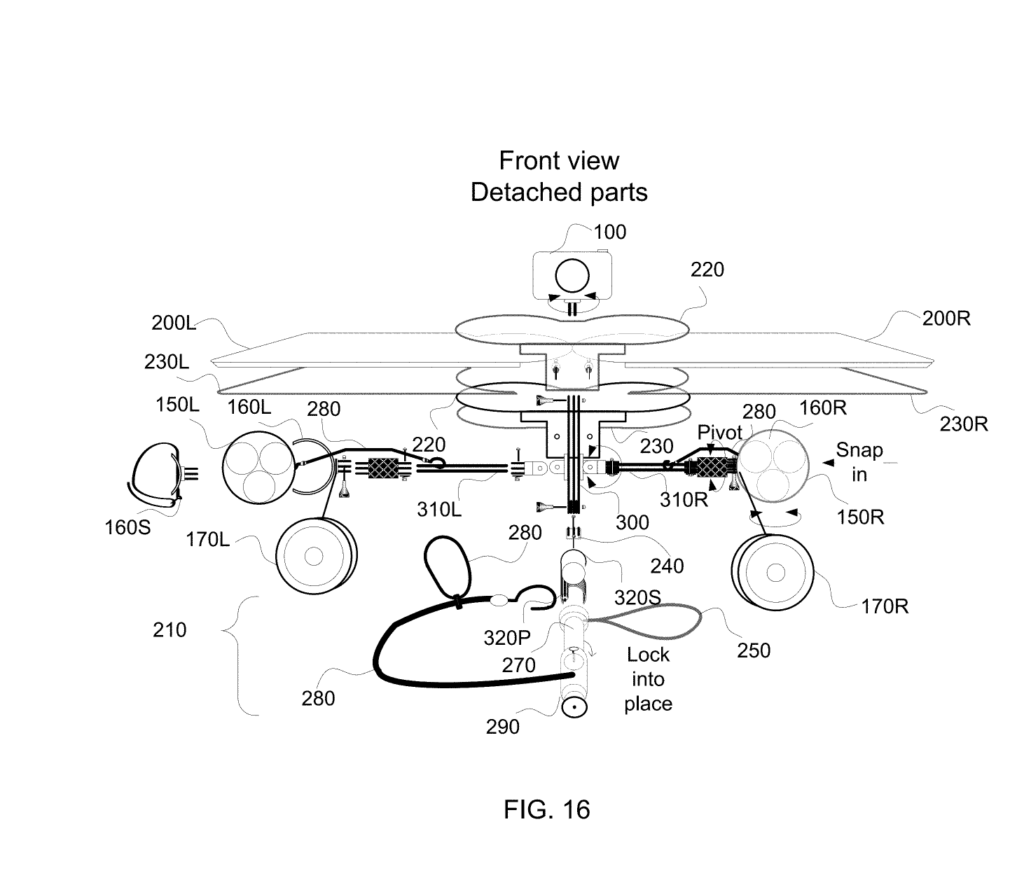

FIG. 16 illustrates an exploded parts view of the preferred embodiment of the application. As shown in the drawing, there are illustrated at least one of: a collapsible stability wing 200L, 200R, a pivot bracket 220, a hinge 300, a camera support 240, a lighting arm 310L, 310R, an extensible shaft 210, an attention shaker 320S, a pencil tool 320P, a handle 290, a wrist strap 250, a camera 100, a tool, a knife 110K, a buoyancy adjustable pad 230, a foam core 270, a bungee cord 280, a light diffuser 170L,170R, and a light bracket option 160L, 160R, 160S.

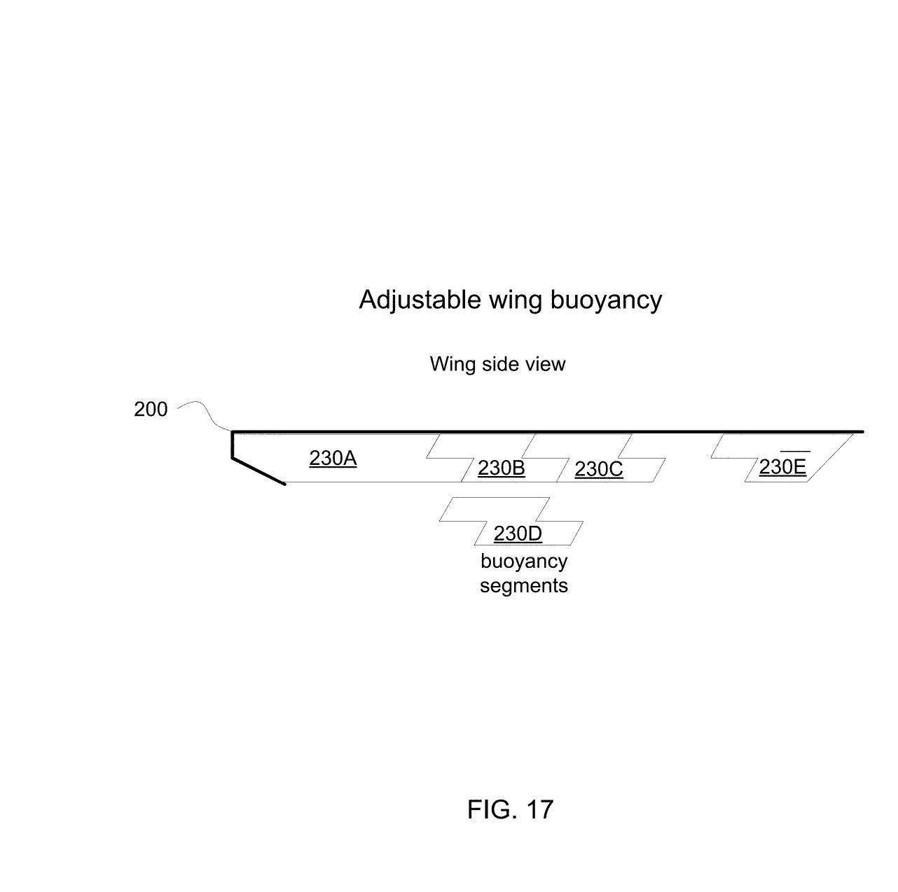

FIG. 17 illustrates a side view of a wing with adjustable wing buoyancy in a preferred embodiment. As shown in the drawing, the wing 200 side view includes five z-profiled buoyancy segments 230A, 230B, 230C, 230D, 230E. A segment 230D has been removed to illustrate that the buoyancy can be adjusted, for example to advantageously compensate for water salinity or weight of equipment in a specific application.

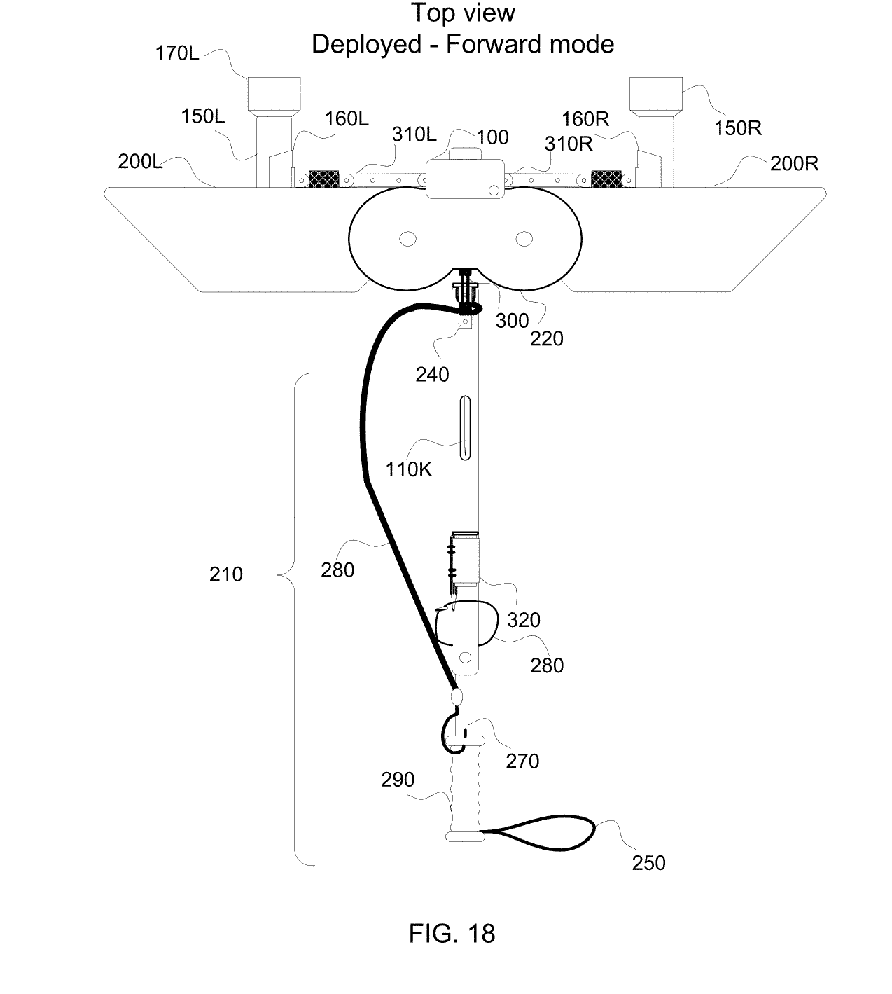

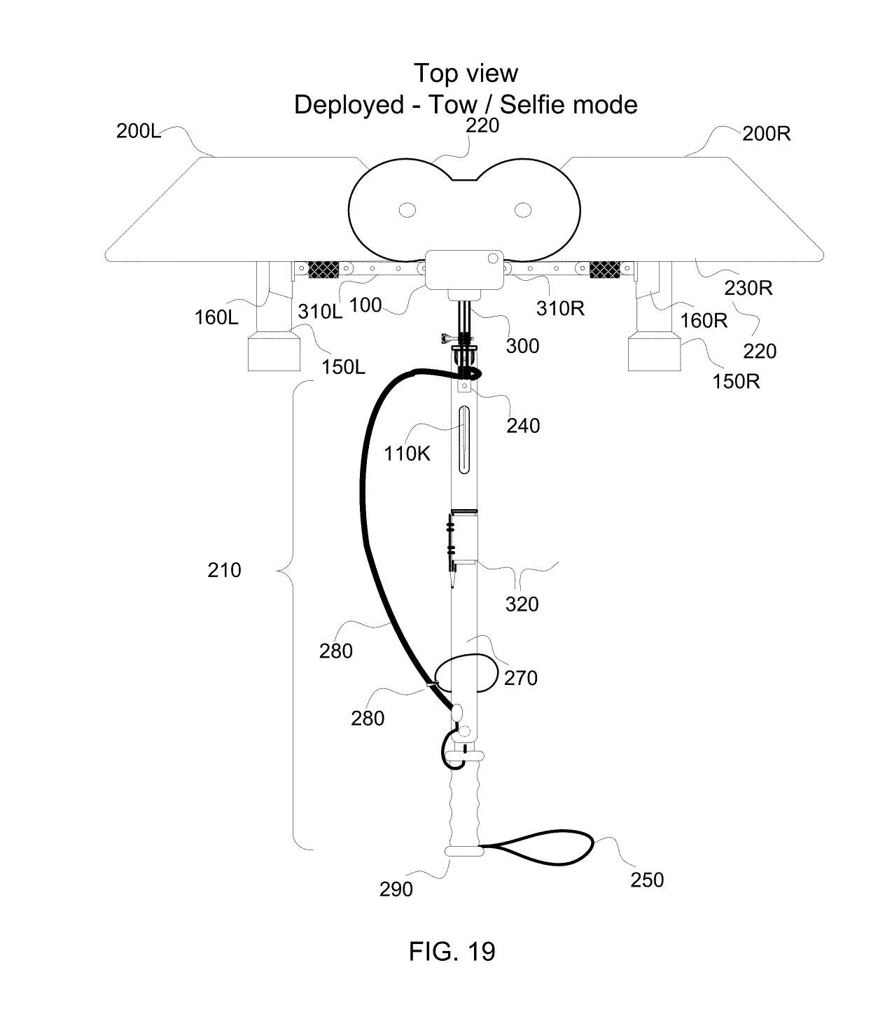

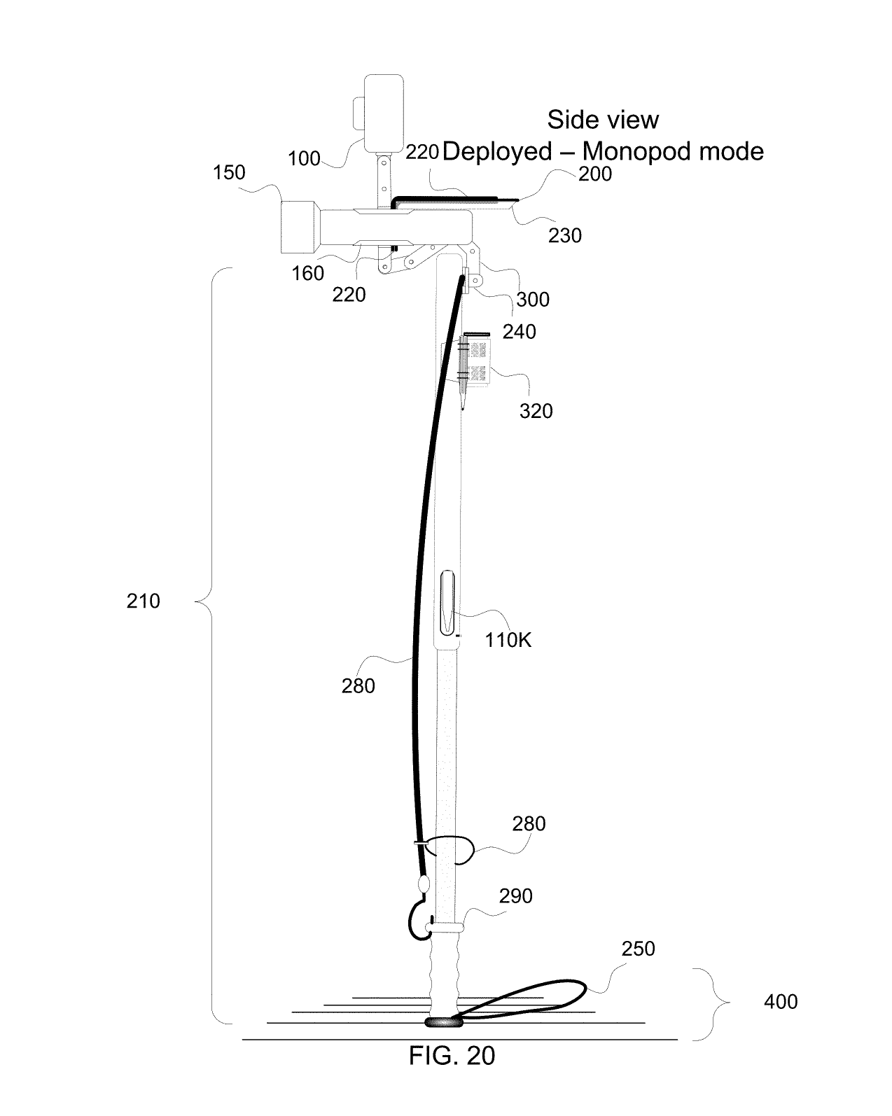

FIGS. 18-25 illustrate various modes of operation of the preferred embodiment of the application, including respectively a deployed forward mode, a deployed tow/selfie mode, a deployed monopod mode, a deployed bottom hover mode, a tool mode, a communication mode, and a collapsed/carrying mode. FIG. 18 illustrates a top view of a preferred embodiment in a deployed forward mode. FIG. 19 illustrates a top view of a preferred embodiment in a deployed tow or selfie mode. FIG. 20 illustrates a side view of a preferred embodiment in a deployed monopod mode.

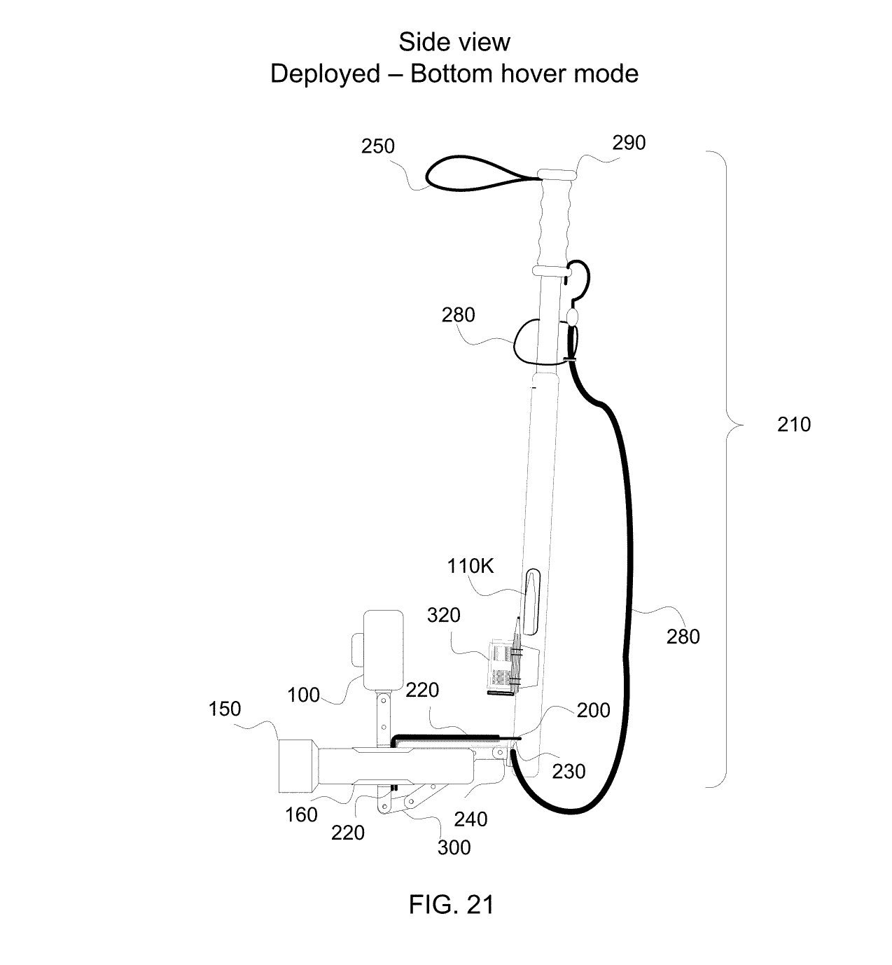

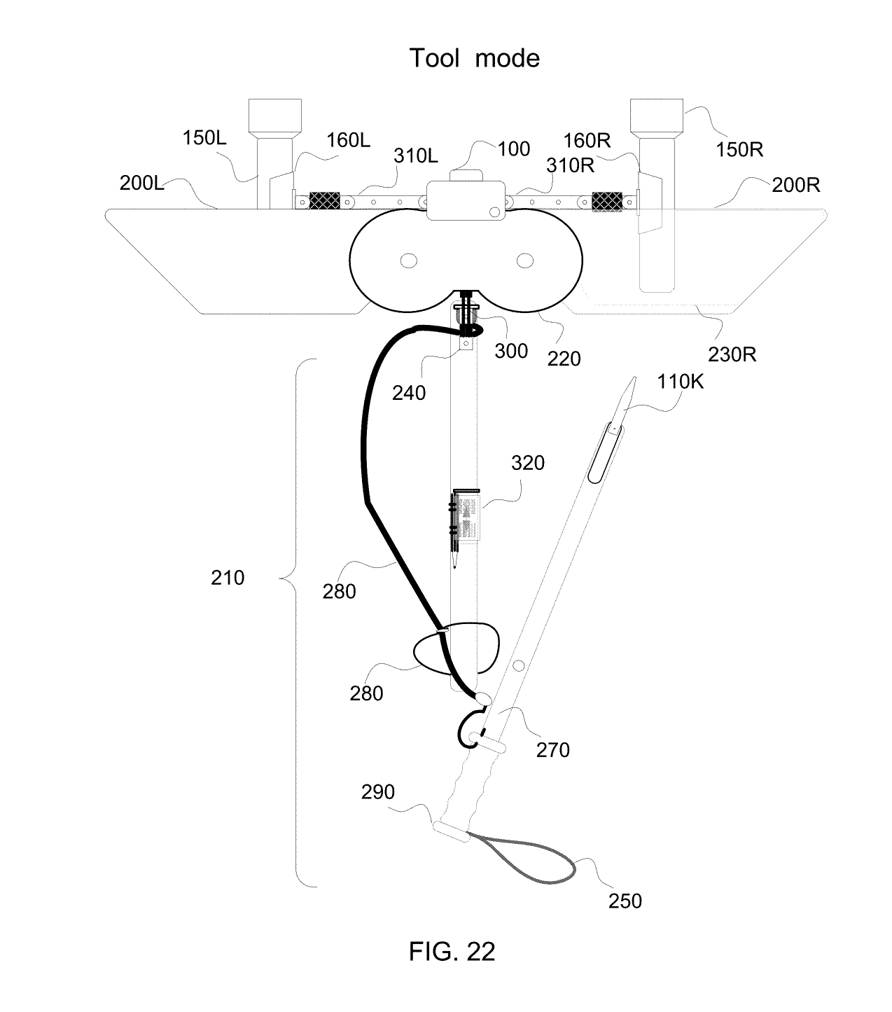

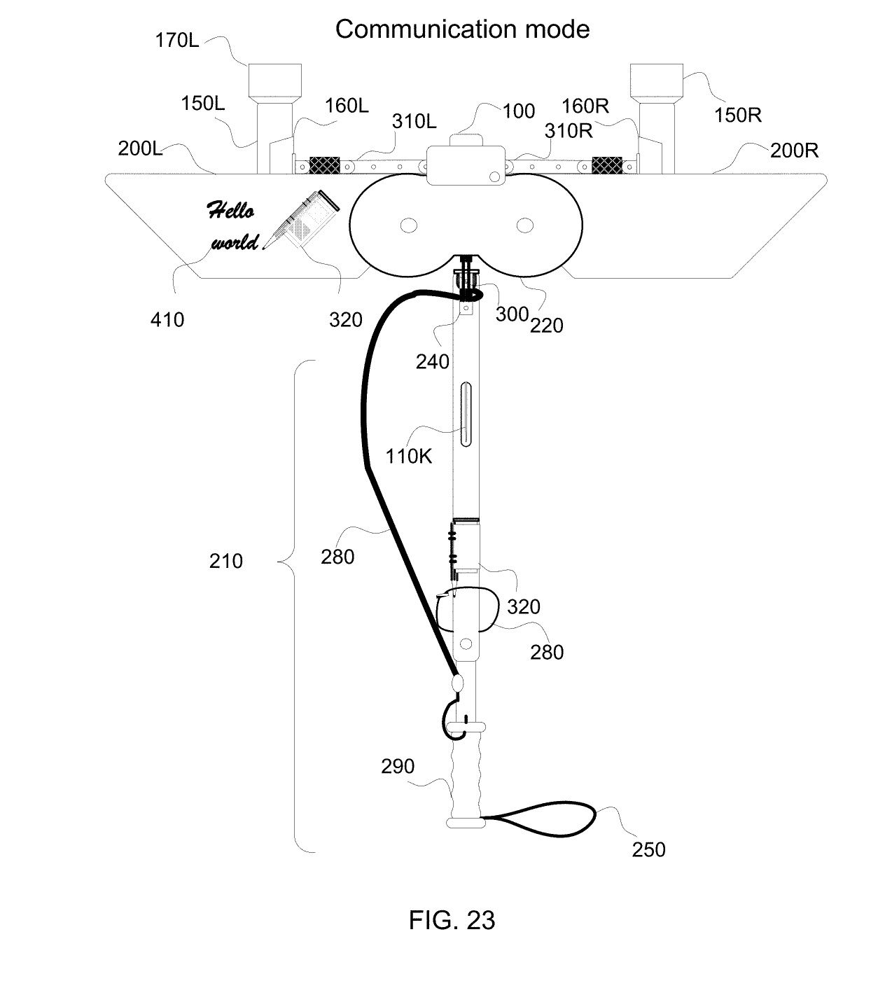

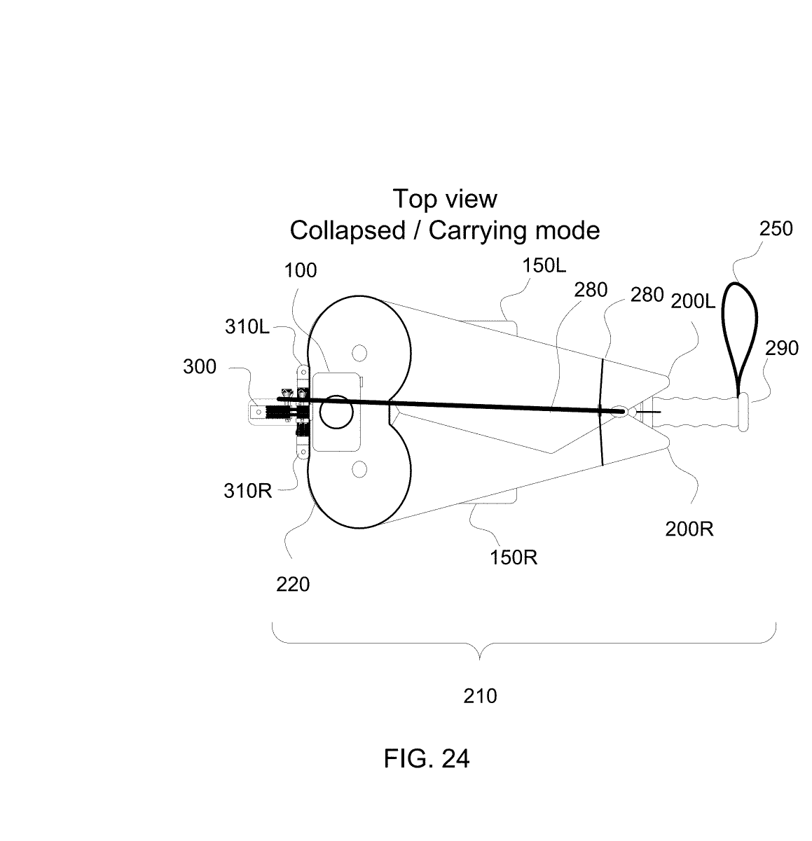

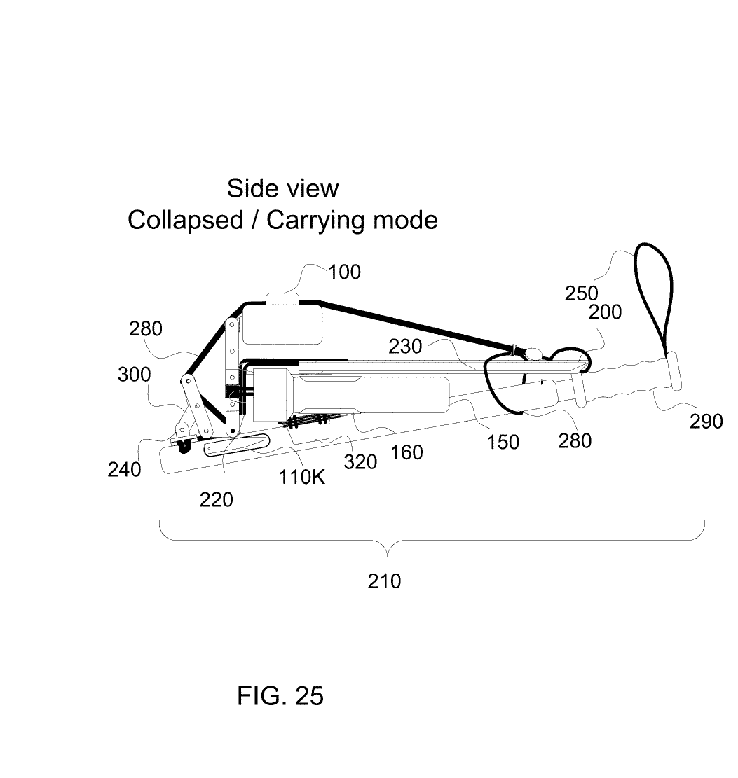

FIG. 21 illustrates a side view of a preferred embodiment in a deployed bottom hover mode. FIG. 22 illustrates a top view of a preferred embodiment in a deployed tool mode. FIG. 23 illustrates a top view of a preferred embodiment in a deployed communication mode. FIG. 24 illustrates a top view of a preferred embodiment in a collapsed or carrying mode. FIG. 25 illustrates a side view of a preferred embodiment in the collapsed or carrying mode.

Several features are illustrated in the embodiment in the drawing: wings 200, foam pads 230, hinge 300, and improved shaft 210.

Although some embodiments exceeded expectation, in some embodiments the added weight of the lighting 150 and wings 200 may be too heavy for some materials, such as for example plastic, for the hinge 300 making it unsteady during operation. In some embodiments, a sturdier material for the hinge 300 is required to solve this issue. In alternate embodiments, many versions and lengths of a folding/rotating aluminium hinge 300 are contemplated. The aluminium hinge 300 enables improved sturdiness, in a way as to be able to position the wings 200,200L,200R aligned to the shaft 210 in a forward and drag-mode or tow/selfie position. This advantageously streamlines the device with very little drag. Additionally, when collapsing the hinge 300 on the device to its compact state, the hinge 300 advantageously sits on the shaft 320 for strength and compactness to sustain accidental impacts to the camera 100, wings 200,200L,200R and lights 150,150L,150R. In some embodiments, the hinge 300 collapses within the shaft 210 length so that the wings 200,200L,200R, photo or video equipment such as camera 100 and lighting 150,150L,150R are not the outermost points on the device. In some embodiment, the hinge 300 has 4 segments, with the first segment being an angled section that connects to the shaft 210 mount 140. Its angle increases the pivot towards the front and centre to enable alignment of the shaft 210 and wings 200, 200L, 200R. The three other segments are straight and of variable lengths, the longest being the camera 100 mount and wing 200,200L, 200R segment. For example, in some embodiments, the angled section is around 2 inches in length, and the other sections are of sufficient number and dimensioned accordingly as would be obvious to a person of ordinary skill in the art in view of the present disclosure for a specific application. In some embodiments, each segment has a thumb screw for easy configuration changes.

A handle 290 was added to the end of the shaft 210 but when deployed in water, the handle 290 end may sink, causing the device to drift vertically. In some embodiments, expanding foam is introduced into the inner channel's 110I core and handle 290, to provide a foam core 270, making the shaft 210 neutrally buoyant, advantageously maintaining the device horizontal with practically no effort required of the operator. In alternate embodiments, the handle 290 also acts as rear rudder, tow point or monopod base depending on its operating mode. In some embodiments, an end cap 350 with a small hole is added to the outer channel to let any leakage escape, thereby improving aesthetics and providing a stronger mount for the base hinge 300 screws.

In some embodiments, the inner channel 110C of the telescopic shaft 110E was also fitted with a tool 110. A knife 110K and other tools can be stored as required. To make use of the tool, the inner channel 110I of the shaft 210 is pulled out from the outer channel 110C keeping both channels 110C, 110I connected by the main bungee 280. The inner channel 110I can rotate inside the outer channel 110C in order to set the handle 290 based on forward or tow position. A bolt screw sets the shaft in lock or release position.

In some embodiments, 2 PVC risers are provided between the shaft 210 and the base hinge 300 to give space to secure a bungee 280 that extends to the handle 290. When in compact state, this helps secure the hinge 300 hooking onto the adjustable hinge 300 screws over the camera 100 and through to the handle 290. A smaller secondary bungee 280 is tethered to the main bungee 280 looped through the shaft 210 securing the wings 200,200L,200R into place.

Although not expressly shown in the drawings, in alternative embodiments, accessory snap on and off receptacles are provided for extra lighting 160S and or accessories 320. These receptacles follow the same build design as the light bracket 160L,160R but with 2 open cylinders joined with openings on opposite sides. In alternative embodiments, some instrumentation options include: dive computer watch pop on: slipped through slots on the cradle, around the receptacle and popped onto the shaft 210; under water compass pop on, whereby the device increases navigation accuracy because it is a gliding lubber line. This keeps the instruments and camera 100 at a glance. In some embodiments, underwater communication is enabled. A snap on and off “shaker” 320S & pencil 320P are used to attract attention and communicate with other divers. The “shaker” 320S is a sounding tube with loose fitting sections of PVC inside and also hosts a pencil 320P. When shaken, it attracts the attention of other divers. The wings 200,200L,200R act as a writing surface 410, along with the pencil 320P, providing an additional communication method as an alternative to hand signals, or when hand signals are insufficient. Snap on accessories options such as a surface buoy, compass or dive computer can be added.

Advantageously, embodiments of the application enable at least one of the following features of sturdiness, practicality, stability, maneuverability, streamlined operation, buoyancy adjustability, underwater tilt protection, extendibility, flexible lighting bracket system, customisable accessories, multi-mode (forward, tow, bottom hover, mono-pod, communication & portability), adjustable wings, hinge, wrist strap and handle, collapsible, easy to carry and hand off when climbing aboard a watercraft, holds lighting and camera close for protection, an attractive and on-trend look, and singlehanded operation.

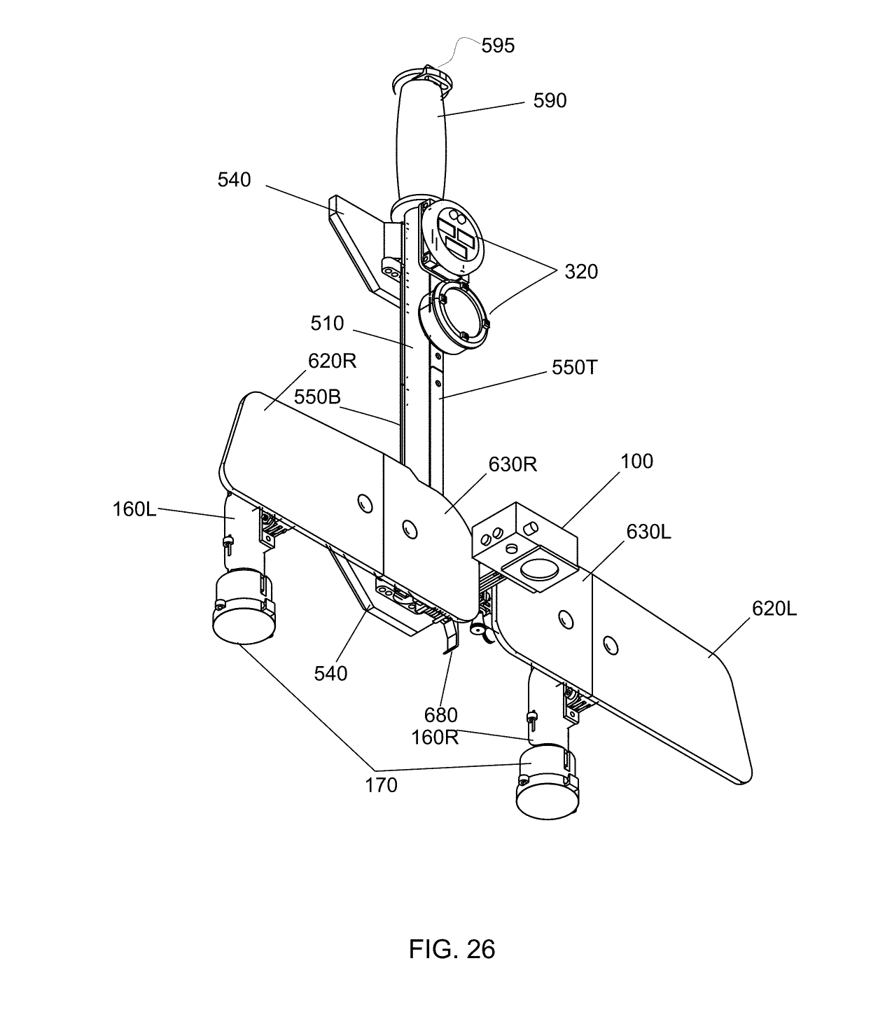

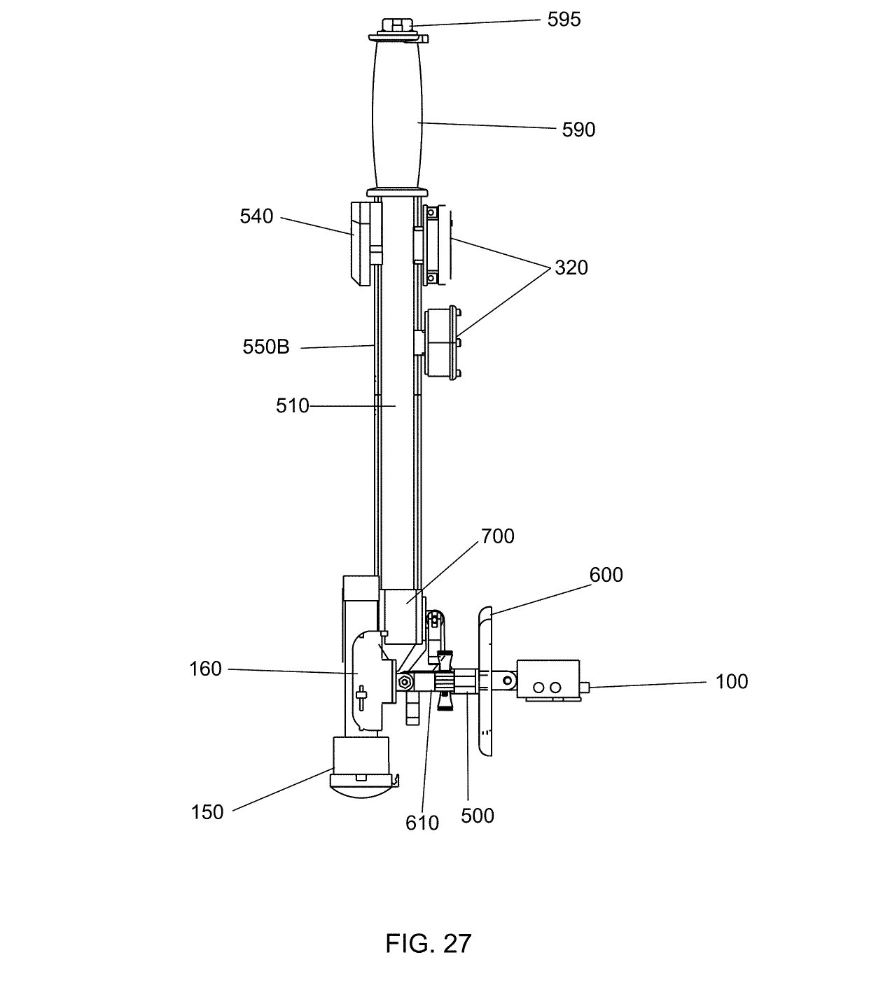

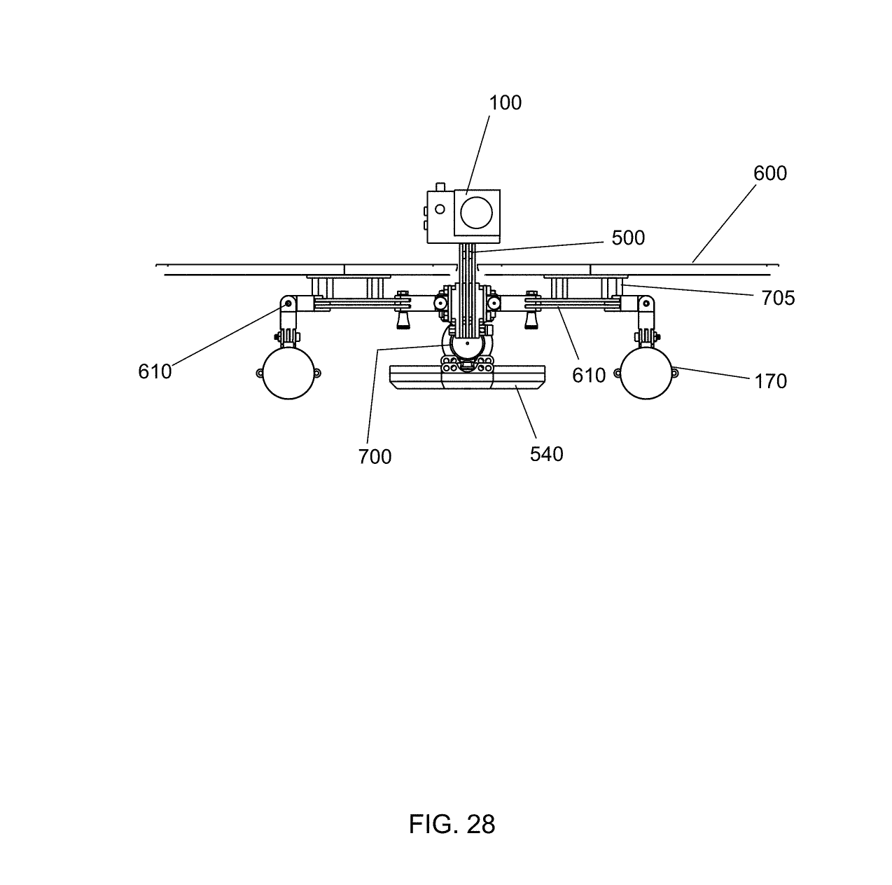

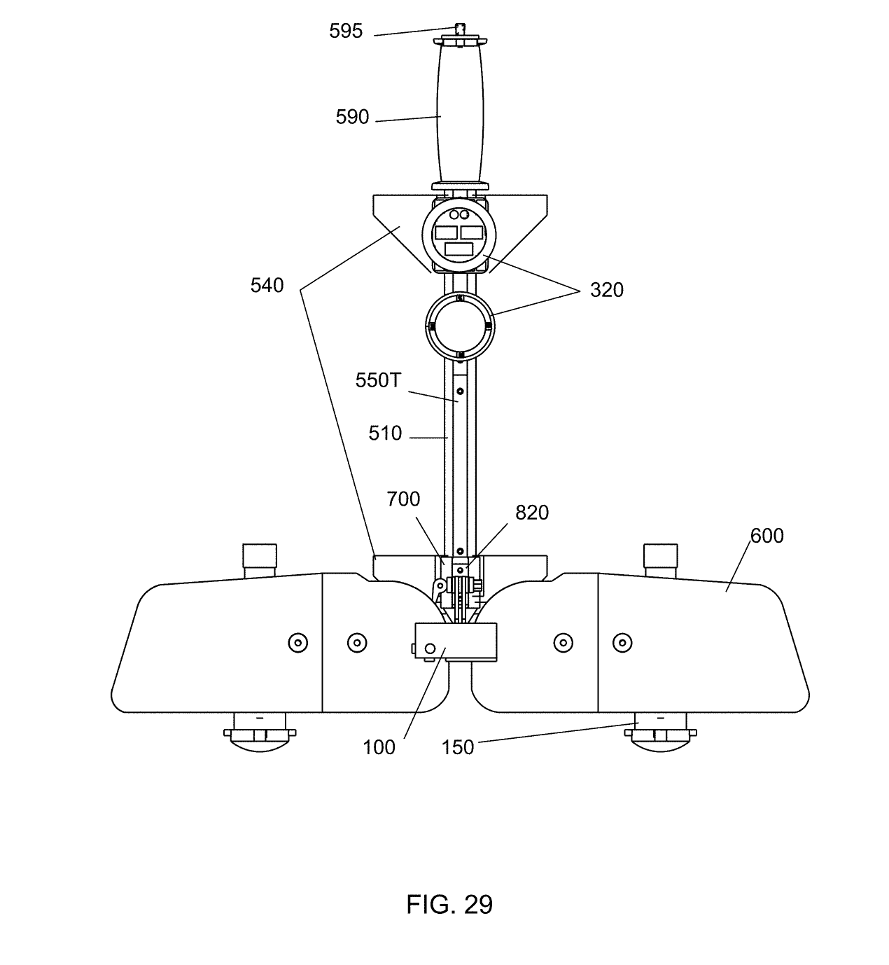

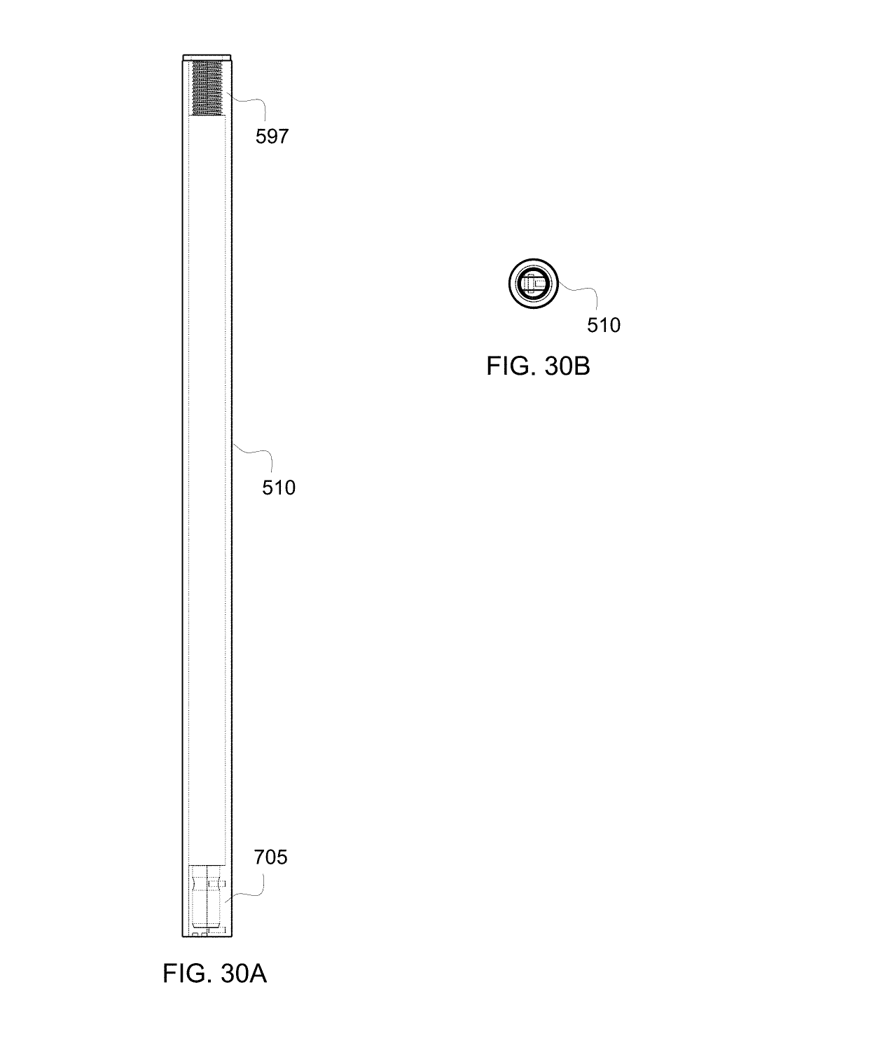

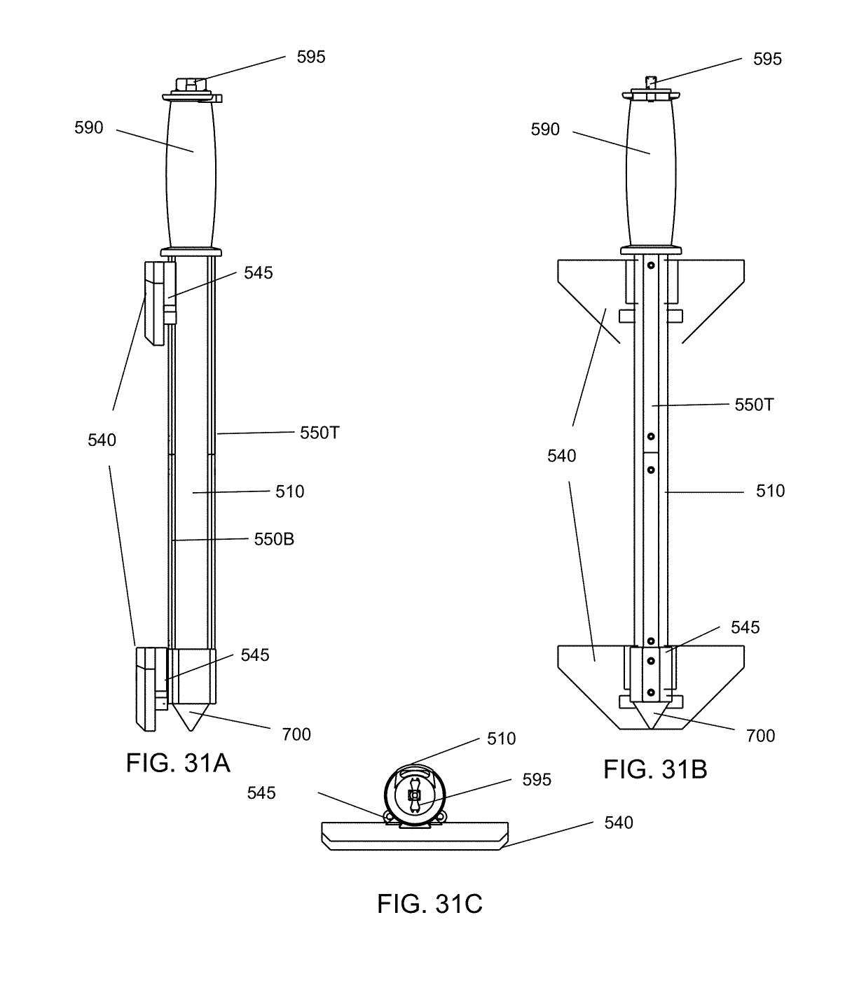

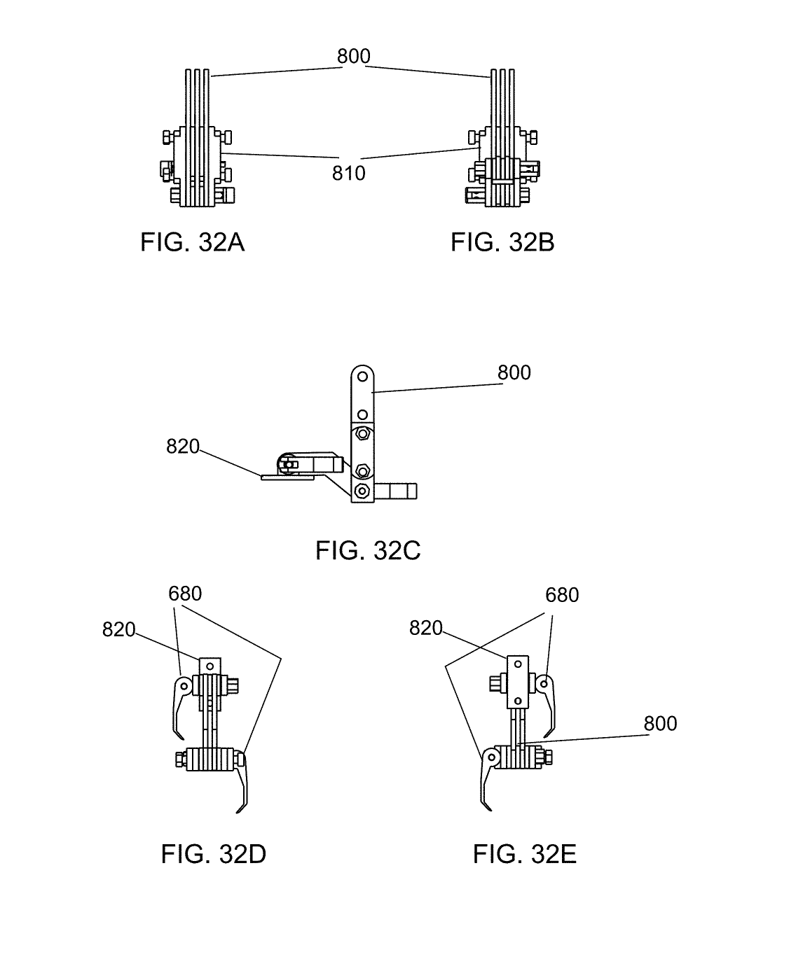

FIG. 26 is a perspective view of an other preferred embodiment of the present application. FIG. 27 is a side view of the other preferred embodiment of the present application. FIG. 28 is a front view of the other preferred embodiment of the present application. FIG. 29 is a top view of the other preferred embodiment of the present application. FIG. 30A is a side view of a basic shaft that can be used in some embodiments of the present application. FIG. 30B is a front view of the basic shaft that can be used in some embodiments of the present application. FIG. 31A is a side view of a shaft head handle base assembly that can be used in some embodiments of the present application. FIG. 31B is a top view of the shaft head handle base assembly that can be used in some embodiments of the present application. FIG. 31C is a rear view of the shaft head handle base assembly that can be used in some embodiments of the present application. FIG. 32A is a front view of a hinge that can be used in some embodiments of the present application. FIG. 32B is a rear view of the hinge that can be used in some embodiments of the present application. FIG. 32C is a side view of the hinge that can be used in some embodiments of the present application. FIG. 32D is a top view of the hinge that can be used in some embodiments of the present application. FIG. 32E is a bottom view of the hinge that can be used in some embodiments of the present application.

Referring to FIGS. 26-28, in a manner similar to an aircraft, as shown in the drawing, a collapsible wing system is provided to either counter vibrations, to reduce rotation, or increase vertical or horizontal stability (roll, pitch and yaw). The wing 600L, 600R rests on wing bracket 505L, 505R attached to the lighting arm 510L, 510R that rotates held in place by screws permitting the wing 600L, 600R to rotate. The pivoting lighting arms 610L, 610R are attached to the hinge 500 shoulder section allowing either angled positions so that the wings 600L, 600R are fully deployed or half deployed where limited width is an issue. Although not expressly shown in the drawing, alternative wing profiles are contemplated, and within the scope of the present application. In some embodiments, the wings always follow the direction of the video or photo camera 100, such as for example by mounting the lighting arms 610L, 610R onto the hinge 500. Different buoyancy configurations may be achieved by adapting different sizes of the outer wing section 620L, 620R to the inner wing section 630L, 630R.

The foam pads 530 added to the base pads 540 are another flexible solution to adjust buoyancy for different lighting system 150 weight and device use in fresh or salt water. With the adjustable buoyancy, in some embodiments, a second light 150L, 150R can be attached thereby having one light under each wing which further balances the device and keeps the camera 100 oriented right side up. In some embodiments, an additional light is added to the shaft rails 550 when additional lighting is needed. Buoyancy can be adjusted by adapting different wing 600L, 600R and base pad 540 length and thickness.

In some embodiments, a handle 590 with a ballast plug 595 was added to the end of the shaft 510 to adjust the desired buoyancy but when heavy lighting is used, the handle 595 end may float, causing the device to drift vertically. In some embodiments, accessories attached to the top 550T and bottom 550B rails can be moved close to the handle 590 end including a counter weight case 560 that can host a knife 110K or other weighted items levelling the shaft 510, advantageously maintaining the device horizontal with practically no effort required by the operator. In alternate embodiments, the handle 590 also acts as rear rudder, tow point or monopod base depending on its operating mode. In some embodiments, the inner channel 110I of the telescopic shaft 110 was also fitted with a tool 320. A knife 110K and other tools can be stored as required. To make use of the tool, the inner channel 110I of the shaft 110 is pulled out from the outer channel 110C keeping both channels connected by a bungee 280.

In some embodiments, an attachment point is provided on the shaft head 660 to secure a bungee 280 that extends to the handle 590. When in compact state, the bungee 280 also acts as a shoulder strap so that the device is easy to carry.

The device's configurable nature is intended to be of an open concept. This enables the user to choose the camera 100, lighting 150 and accessories 320 of his choice. The device's main configuration properties are; buoyancy, balance, self-righting, multi-mode and accessories adaptability. It provides a maneuverable tool for underwater exploration, navigation, photo and video capture while keeping all instruments at a glance. It is not limited to these main uses as it may adapt most any other underwater accessories such as a spear fishing gun, surface buoy, writing slate and pencil etc.

The following description of an embodiment is broken down into 4 main components with its own sub-components. The main components are the shaft 510, the hinge 500, the lighting arms 610 and wings 600, the console rail 550 and accessories 320.

The shaft 510 is the main trunk, and in alternative embodiments includes at least one of the following features: buoyancy adjustable ballast, pitch balanceable, rail accessories hosting, maneuverable, and extendable. The shaft 510 is the backbone of some embodiments. It hosts a handle 590, a top 550T and bottom 550B rail system, base pads 540 and the main head 700 where its hinge 500, wings 600 and lighting 150 is attached. The shaft 510 along with the handle 590 and head 700, acts as ballast where the ratio of water versus air can be adjusted. This helps solve the problem of achieving neutral buoyancy when various accessories are added and when operating in fresh or salt water. (salt water is 3% denser).

The handle 590 slides over the main shaft 510 up to and slightly over the rails 550 and is locked in place by a ballast plug 595 screwing into a threaded sleeve 597 within the shaft 510. This aspect makes it possible to easily remove the handle 590 to add or remove accessories from the rails 550, adjust the shaft's 510 inner water or air volume to reduce or increase buoyancy depending on the load created by devices attached.

In some embodiments, a wrist strap 250 is provided to secure the device to the user's wrist while in use under water or while carrying above water.

The ballast plug 595 screw's within the shaft 510 sleeve 597. It is slightly larger than the inner diameter of the handle 590 preventing it from slipping off the shaft 510 and making the shaft 510 water tight. It hosts a hole that allows a bungee 280 to be threaded through it without hindering the action of screwing and unscrewing the ballast plug 595.

The bungee 280 is uses to tether the ballast plug 595 to the handle 590. The bungee 280 is threaded through the hole on the ballast plug 595 so that it may pivot (when screwed) independently from the bungee 280.

The threaded sleeve 597 is secured within the shaft 520. The shaft sleeve 597 and the ballast plug 595 make the shaft 520 water tight allowing the desired buoyancy.

Interlocking rails 550 appear on the top 550T and bottom 550B of the device. The number of rails installed can vary depending on the device length required. They are used to host and secure various accessories 320. The accessories can slide over the rails to adjust and balance the device pitch. (Roll, Pitch and Yaw) This enables the device to be maneuvered effortlessly and improve its stability.

The head 700 is the focal point between the shaft 520 and wing 600\camera 200\lighting arms 510 of the device. It is designed with a short rail 710 to adapt a base pad 540 where buoyancy is most needed. It is configured with two sleeves that host two hollow pins. The sleeves and hollow pins 705 are designed to increase the strength of the head 700 and to prevent breakage where the hinge 500 is mounted to the head. Reinforcement pins fit into the head. They are hollow in order to host screws that fasten the hinge mount 820.

The plug 595 has two hollowed cylinders to host the tip of the hinge 500 mount screws. This ensures that the seal the shaft 510 is preserved and ensures the ballast function of the device.

The hinge mount 505 allows 180 degrees of pivoting adjustment. It hosts the device hinge 500 section.

The base pad 540 is designed to host a rail sleeve 545 and cotter pin to lock the rail sleeve 545 into place. They act as the devices feet for when it is resting on dry land. In water, they help with the device buoyancy and pitch balance. The rail sleeve 545 design allows the use of variable pad 540 sizes to get the desired buoyancy. Additional buoyance can be attached in the form of a foam pad 530. The rail sleeve 545 is made denser than the pad 540 in order to support the weight of the device on land while preserving the buoyancy characteristic of the assembled object. The cotter pin locks the rail sleeve in place on the pad of the user's choice.

A bungee loops through the four holes of the pad 540. The two resulting loops secure the wings 600 in place when carrying the device. It can also attach extra buoyancy foam pads 530 to increase needed buoyancy.

The hinge 500 pivots 270 degrees permitting various device modes such as: bottom, monopod, selfie, travel and forward mode. When in travel mode, the hinge 500 folds within the shaft 510 length giving additional protection the devices accessories such as submersible lights and camera. Two sections of interconnecting blades 800 are combined with holes aligned to attach the locking system and wings 600 \ lighting system 150. Quick locks 680 permit easy and sturdy configuration of the various modes available with the device. The shoulder and spacers 810 enable the functioning of the quick locks 680 by creating space and prevent the blades 800 from bending when the quick locks 680 are secured without hindering the pivoting of the hinge. The main attachment point of each wing use 2 bolts with locking nuts to keep the hinge section together.

The wings 600 offer stability and buoyancy to the device. They are configured in two tongue and groove sections to enable various wing configurations to adjust buoyancy based on the loads added to the device. Two attachment points give 705 each wing its rigidity and strength. The wing brackets 505 are used to attach the wing 600 to the lighting arms 610. They create space between the wing 600 and lighting arm 610 to host lights 150 attached to the device. The outer section is designed to sit on and host a pivot. It does not limit pivot movement of the lighting 150 and helps shorten the lighting arm 610 to reduce the weight stress on the shoulders.

The wing washers fit in sleeves on each section of a wing 600. They are made denser so that the wings 600 can be bolted to the lighting arms 610 without fear of breaking the wings 600 if over tightened. This makes the wing fastening point stronger avoiding the loss of wing buoyancy if they were to be over tightened.

The lighting arms 610 are used to hold submersible lights 150. They can fold along the shaft 510 making the device compact for travel purposes or deployable when in use. They allow pivoting of the lights in horizontal and vertical direction. The arm blades have horizontal pivots at each end and hold the wing and wing brackets in place. The light safety tether adds a layer of security in case of breakage or mishap. They also prevent the blades from bending where the wing is bolted. Attached to the arms blades, it enables the light adapter to move in the desired lighting direction. The hook and loop, such as for example Velcro®, light adapter 160S holds various sizes of submersible lights. Two cylinder holes can host a bungee cord in order to secure a light diffuser 170. Reinforcement pins fit into the light adapter. They are hollow in order to host screws that fasten the pivot mount. The hollow pin design increases the fastening strength of light adapter to the pivot and prevents breakage when screwed. Two hook and look straps are used to secure the light in place. The pop-on light adapter holds a specific size of submersible light. It is very convenient when attaching or removing lights to the device. Two cylinder holes can host a bungee cord in order to secure a light diffuser. The light diffuser is housed on the front of a high intensity light. It prevents hot spots when capturing photos and videos in dark or low light conditions. It is tethered to the light holder with a bungee cord and can be parked at the back of the light when not needed. It is white in color to render a diffused white light. The bungee runs through the holes on each side of the diffuser and attaches to the light holder.

Various adapter and accessories can be mounted on the rails and placed in a position to preserve the pitch balance of the device. The compass holder has four holes aligned with standard scuba compass mounts and is attached with two tie-wraps. It aligns the compass's lubber line to the device shaft increasing navigation precision. The dive computer holder has four holes aligned with most dive computers and is attached with 2 tie-wraps. It aligns the dive computer perpendicular to the device shaft making it easy to read at a glance. The dive computer holder wrist model has four tabs keeping the wrist straps secured. It loops over the holder and around the shaft. The case is used to hold various accessories such as a knife, pencil. When a dense object is housed, it can act as a counter balance when/if the shaft is too buoyant. The bungee is threaded through the hole on the ballast plug so that it may pivot (when screwed) independently from the bungee. The light holder ring is used to add additional lighting to the device. In device configurations where the mils do not extend the length of the shaft, it can pivot around the shaft holding a parked position when on top (travel mode) or deployed position when below (operating modes). The pivots allow the direction adjustment of the lighting. The same type of light holder is used as in above section; Light adapter—hook an loop or light adapter—pop-on. The same type of light diffuser is used as in above section.

The above-described embodiments of the present invention are intended to be examples only. Those of skill in the art may effect alterations, modifications and variations to the particular embodiments without departing from the scope of the application, which is set forth in the claims.

What is claimed is:

1. A multi-modal underwater camera accessory apparatus operable in multiple modes by an operator, the apparatus comprising:
(a) a shaft having a proximal end and a distal end, the proximal end suitable for manipulation by the operator;
(b) a camera mount connected to the shaft proximate to the distal end of the shaft, the camera mount suitable for receiving the underwater camera to be manipulated by the operator; and
(c) a wing rotationally connected to the shaft such that the wing may be configured by the operator in at least one of two positions including:
(i) a first position whereat the wing is at a first angle with respect to the shaft; and
(ii) a second position whereat the wing is at a second angle with respect to the shaft, the second angle being smaller than the first angle;
such that the mode of operation of the apparatus is depends on the at least one of two positions of the wing.

2. The apparatus according to claim 1, further comprising a second wing which is a mirror image of the first said wing, the second wing rotationally connected to the shaft such that the second wing may also be configured in at least one of the said first and second positions.

3. The apparatus according to claim 1, wherein the camera mount enables the operator to orient the underwater camera towards a subject at an arbitrary angle with respect to the shaft.

4. The apparatus according to claim 3, wherein the arbitrary angle is aligned with the shaft.

5. The apparatus according to claim 3, wherein the orientation of the underwater camera is towards the operator such that the operator is in the field of view of the underwater camera.

6. The apparatus according to claim 3, wherein the orientation of the underwater camera is away from the operator such that the operator is not in the field of view of the underwater camera.

7. The apparatus according to claim 1, wherein the shaft includes an inner channel, an outer channel, and a mechanism to set the length of the shaft through operator manipulation.

8. The apparatus according to claim 7, wherein the mechanism to set the length of the shaft includes at least one of: a groove, a hole provided on the outer channel, a screw, and a quick lock ring provided on the outer channel for collapsing the outer channel onto the inner channel.

9. The apparatus according to claim 7, wherein the mechanism to set the length of the shaft includes a spring loaded pin provided on the inner channel and at least one hole provided on the outer channel.

10. The apparatus according to claim 7, wherein the inner channel further includes a tool such that when the inner channel is removed from the outer channel, the tool can be used by the operator.

11. The apparatus according to claim 10, wherein the tool is a knife.

12. The apparatus according to claim 1, wherein the shaft includes a buoyancy component to affect the buoyancy of the apparatus.

13. The apparatus according to claim 12, wherein the buoyancy component includes a ballast for receiving one of a substance that is lighter than water, heavier than water, and the same weight as water.

14. The apparatus according to claim 13, wherein the buoyancy component includes at least one of a foam pad slidably engaged onto the shaft, a foam core provided inside the shaft, a chamber formed inside the shaft, and a chamber attachable to the shaft.

15. The apparatus according to claim 1, wherein the shaft includes a ballast plug provided at one end of the shaft to create a ballast chamber inside the shaft.

16. The apparatus according to claim 1, wherein the shaft includes an accessory adapter that snaps onto the shaft to receive at least one of a light, a shaker tool, a knife, a counter weight case, a dive computer, a compass, and a bungee cord.

17. The apparatus according to claim 1, wherein the camera mount includes a hinge including at least two segments and a rotational component, the hinge thereby allowing the operator to orient the camera with respect to two degrees of freedom relative to the shaft.

18. The apparatus according to claim 1, wherein the wing is rotationally connected to the shaft by one of a pivot bracket and a lighting arm.

19. The apparatus according to claim 1, further including a lighting arm having two ends, the lighting arm connected at one end to the shaft proximate to the camera mount, the lightning arm connected at the other end to at least one of a light bracket that allows the operator to add a light and a wing bracket connected to the wing.

20. The apparatus according to claim 1, wherein the mode of operation includes at least one mode selected from a deployed mode, a stowed mode, a forward mode, a selfie mode, a bottom hover mode, a monopod mode, a tool mode, a writing mode, and a reduced width mode.
